(19) United States
(12) Patent Application Publication
(10) Pub. No.: US 2024/0210200 A1
(43) Pub. Date: Jun. 27, 2024

(54) GENERATING DYNAMIC INTERFACES PROVIDING INTELLIGENT MULTI-DEVICE SELECTABLE ELEMENTS FOR A TRANSPORTATION MATCHING SYSTEM

(71) Applicant: Lyft, Inc., San Francisco, CA (US)

(72) Inventors: Amira Zakiyya Anuar, San Francisco, CA (US); Srishti Kapur, Brooklyn, NY (US); David Bruce Lindsay, Kirkland, WA (US); Benjamin Jonas Plaut, Pittsburgh, PA (US); Shashi Kant Sharma, Redwood City, CA (US); Parul Shukla, Mountain View, CA (US); Brandon Douglas Souba, San Francisco, CA (US); Benjamin Upsavs, San Francisco, CA (US)

(21) Appl. No.: 18/146,850

(22) Filed: Dec. 27, 2022

(51) Int. Cl. G01C 21/36; G06Q 50/30

(52) U.S. Cl. CPC G01C 21/3667; G01C 21/3611; G06Q 50/30

(57) ABSTRACT

The present disclosure relates to systems, non-transitory computer-readable media, and methods for generating dynamic graphical user interfaces that provide intelligent multi-device selectable elements for a transportation matching system. In particular, in one or more embodiments, the disclosed systems compare features associated with multiple transportation requests and features associated with a provider device utilizing a multi-device selection model. In addition, the disclosed systems can intelligently surface a subset of transportation requests to graphical user interfaces of individual provider devices. For instance, the disclosed systems provide selectable elements within an interactive digital map so that provider devices can efficiently and accurately select transportation matches within a consolidated user interface. Moreover, in some embodiments, the disclosed systems provide individual transportation requests to multiple provider devices and intelligently resolve overlapping conditions utilizing a provider selection model.

### BACKGROUND

Recent years have seen significant development in transportation matching systems that utilize web and mobile applications to match provider devices to real-time on-demand transportation requests from requestor devices. For example, on-demand transportation matching systems can utilize computer networks to match provider devices with requestor devices to provide transportation across a variety of contexts. In generating dynamic transportation matches, conventional systems can select and communicate with provider devices for providing transportation services for a particular requestor device at particular times and in particular geographic regions. Although on-demand transportation matching systems can identify requestor devices, select provider devices, dispatch provider devices, and dynamically match requestor devices and provider devices, such systems suffer from a number of technical problems, particularly in flexibility, efficiency, and precision of implementing computer systems.

For instance, conventional systems offer limited flexibility for matching client devices during a transportation request. To illustrate, while conventional systems may allow a provider device to select a particular driving mode, geographic area, or timeframe for responding to transportation requests, such systems generally assign rigid transportation assignments to provider and requestor devices within these parameters. For instance, conventional systems typically perform a background analysis of available transportation requests, select a transportation match, and then rigidly surface driving instructions to the provider device.

Additionally, conventional systems are inefficient. For instance, the rigid approach described often leads conventional systems to waste computer resources and utilizes excessive bandwidth. For example, provider devices faced with a rigid assignment to a particular transportation request will often review user interfaces indicating details regarding the transportation match, change a mobile application to an offline status (or otherwise submit a cancellation notice for the transportation request), switch the mobile application back to online status, submit an additional query for an additional transportation request, await for backend servers to identify an additional transportation match, review additional user interfaces regarding the additional transportation match, and re-evaluate the additional transportation match for compatibility (or additional interactions to cancel the additional transportation match). Indeed, conventional systems can iteratively repeat this process before provider devices accept a transportation match. This not only wastes computer resources of the provider device, but backend servers utilize significant computer resources in iteratively managing transportation matches, processing cancellation requests, and reassigning requests across multiple provider devices. Thus, conventional user interfaces provide inefficient elements that result in inefficient utilization of computing resources in managing transportation requests.

Furthermore, a number of technical barriers exist to providing multiple transportation options to provider devices. For example, limited screen space and functional capacity of mobile devices introduces a significant barrier to providing accurate and sufficient information in an efficient manner to provider devices. This is especially true given that provider devices are often utilized while operating a transportation vehicle. To illustrate, providing a written list of transportation requests would introduce additional inefficiencies as provider devices seek to glean information regarding each transportation request and navigate to other user interfaces to compare the written information with transportation details. Similarly, providing multiple transportation requests has the potential to introduce overall system inefficiencies as certain transportation requests for certain requestor devices are repeatedly presented to various provider devices without finalizing a transportation match. Similarly, providing multiple transportation requests could lead to inefficiencies and conflicts across provider devices that select the same transportation request to service. Furthermore, the number of available transportation requests for a particular region would exhaust and overwhelm the available space of conventional user interfaces and displays.

These along with additional problems and issues exist with regard to conventional transportation matching systems.

### BRIEF SUMMARY

Embodiments of the present disclosure provide benefits and/or solve one or more of the foregoing or other problems in the art with systems, non-transitory computer-readable media, and methods for generating dynamic graphical user interfaces that provide intelligent multi-device selectable elements for a transportation matching system. In some embodiments, the disclosed systems can compare features associated with multiple transportation request and features associated with a provider device utilizing a multi-device selection model. Based on this analysis, the disclosed systems can intelligently surface a subset of transportation requests to graphical user interfaces of individual provider devices. For instance, the disclosed systems provide selectable elements within an interactive digital map so that provider devices can efficiently and accurately select transportation matches within a consolidated user interface. Moreover, in some embodiments, the disclosed systems provide individual transportation requests to multiple provider devices and intelligently resolve conflicting selections utilizing a provider selection model. Accordingly, the disclosed systems can provide efficient user interfaces that allow for improved flexibility and accuracy in providing multiple transportation requests to provider devices.

The following description sets forth additional features and advantages of one or more embodiments of the disclosed methods, non-transitory computer-readable media, and systems. In some cases, such features and advantages are evident to a skilled artisan having the benefit of this disclosure, or may be learned by the practice of the disclosed embodiments

### BRIEF DESCRIPTION OF THE DRAWINGS

The detailed description provides one or more embodiments with additional specificity and detail through the use of the accompanying drawings, as briefly described below. The drawings are not necessarily drawn to scale.

FIG. 1 illustrates a diagram of an environment in which a multi-device selection system can operate in accordance with one or more embodiments.

FIG. 2 illustrates an overview of a transportation matching system receiving a set of transportation requests and providing for display selectable elements indicating a plurality of transportation requests to a provider device in accordance with one or more embodiments.

FIGS. 3A-3B illustrate the transportation matching system analyzing transportation request features and selecting between a multi-device selection system and a single-device selection system in accordance with one or more embodiments.

FIG. 4 illustrates a multi-request transportation model selecting a plurality of transportation requests from a set of transportation requests to provide to a provider device in accordance with one or more embodiments.

FIGS. 5A-5C illustrate example graphical user interfaces for displaying selectable elements indicating the plurality of transportation requests in accordance with one or more embodiments.

FIG. 6 illustrates the provider selection model selecting a provider device from a plurality of provider devices to match with a selected transportation request in accordance with one or more embodiments.

FIG. 7 illustrates a flowchart of a series of acts in a method of selecting a plurality of transportation requests and providing an interactive digital map and selectable elements indicating the plurality of transportation requests in accordance with one or more embodiments.

FIG. 8 illustrates a block diagram of an example computing device for implementing one or more embodiments of the present disclosure.

FIG. 9 illustrates an example environment for a transportation matching system in accordance with one or more embodiments.

### DETAILED DESCRIPTION

This disclosure describes one or more embodiments of a multi-device selection system that generates improved graphical user interfaces that provide intelligent multi-device selectable options to provider devices within a transportation matching system. For example, the multi-device selection system selects a plurality of transportation requests and provides a user interface for display on a provider device that illustrates an interactive map and selectable elements indicating the plurality of transportation requests. In particular, in one or more implementations, the multi-device selection system identifies features associated with each transportation request (e.g., destination, type, route, etc.). The disclosed systems can utilize a multi-device selection model to analyze these features and features associated with each provider device to select which transportation requests to provide to each provider device. Once selected, the multi-device selection system can surface selectable elements representing the selected transportation requests with an interactive map. Upon surfacing selectable elements indicating transportation requests, the multi-device selection system receives a selection of a selectable element from a provider device and transmits navigation instructions of a pickup location associated with the transportation request to the provider device.

As indicated above, the multi-device selection system receives a set of transportation requests and selects a subset of transportation requests to display on a provider device. Upon receiving a transportation request, the multi-device selection system identifies features associated with the transportation request and utilizes a transportation request filter to determine whether to funnel the transportation request into a multi-request transportation model, a single-request transportation model, or both. For instance, in one or more embodiments, the multi-device selection system selects transportation requests for the multi-request transportation model based on a threshold wait time and/or a previous interaction between a provider device and the transportation request.

In addition to selecting transportation requests for the multi-request transportation model, the multi-device selection system can identify features associated with each transportation request and features associated with each provider device. Moreover, the multi-device selection system utilizes a multi-request transportation matching algorithm to compare the features associated with the transportation requests and features associated with the provider devices. For example, in some implementations, the multi-request transportation matching algorithm utilizes an optimization model (e.g., a local greedy optimization model or a global optimization model) to analyze these features and select transportation requests to surface to different provider devices. In particular, the multi-device selection system can intelligently select which transportation requests (and how many transportation requests) to match to which provider devices (and how many provider devices). For instance, the multi-device selection system can surface three selectable elements corresponding to three transportation requests with an interactive map on a first provider device and surface four selectable elements corresponding to four different transportation requests with an interactive map on a second provider device.

The multi-device selection system can surface selectable elements within an intelligent user interface that efficiently provides pertinent information to provider devices. For example, the multi-device selection system can provide selectable elements in conjunction with an interactive map. The selectable elements can include information regarding the transportation request and the interactive map can display transportation routes and/or other information corresponding to particular transportation requests.

The multi-device selection system can also dynamically modify user interfaces of provider devices. For example, as the multi-device selection system matches transportation requests to provider devise, the multi-device selection system can update user interfaces of other provider devices to remove selectable elements corresponding to matched transportation requests. Moreover, as the multi-device selection system receives additional transportation requests, the multi-device selection system can intelligently update user interfaces to surface the additional transportation requests to selected (e.g., optimal) provider devices.

As mentioned, in some implementations, the multi-device selection system provides the same transportation request to multiple provider devices. Indeed, to improve efficiency and reduce time and queries for requestor devices, the multi-device selection system can select a number of provider devices to receive a single transportation request from a single requestor device. Accordingly, in some circumstances multiple provider devices may select the same transportation request. In such circumstances, the multi-device selection system can intelligently select between provider devices. For example, the multi-device selection system utilizes a provider selection model (e.g., a separate optimization algorithm) to select a provider device (e.g., an optimal provider device) for the particular transportation request.

The multi-device selection system can also provide a variety of other intelligent features in surfacing multiple transportation requests from multiple requestor devices to provider devices. For example, the multi-device selection system can stagger timing in providing transportation requests to different provider devices, implement gating based on various factors such as provider device and/or requestor device ratings (e.g., provide high-value transportation requests to highly rated provider devices), and/or implement provider device incentives based on utilizing the multi-request transportation matching algorithm (e.g., provide priority matches or other incentives in utilizing multi-request transportation features).

The multi-device selection system provides many advantages and benefits over conventional system and methods. For example, by utilizing a multi-request transportation model, the multi-device selection system provides improved flexibility and computer functionality. In particular, the multi-device selection system can dynamically select transportation requests utilizing a multi-request transportation matching algorithm allowing provider devices to display and select from numerous transportation match combinations. Additionally, as certain transportation requests become available or unavailable, the multi-device selection system dynamically updates selectable elements associated with transportation requests on provider device interfaces. Furthermore, the multi-device selection can flexibly select between different transportation matching models for different transportation requests. For instance, based on features associated with a transportation request, the multi-device selection system can flexibly decide to apply a multi-request transportation model, a single-request transportation model, or both.

Additionally, the multi-device selection system improves efficiency of implementing devices. For instance, the multi-device selection system provides improved user interfaces to provider devices that reduce user interactions and computing resources. For example, the multi-device selection system provides user interfaces via provider devices that include transportation information regarding a subset of intelligently selected transportation requests. Thus, via a single user interface, the multi-device selection system allows provider devices to identify, review, and select from multiple transportation requests. In addition, by providing transportation requests to multiple provider devices, the multi-device selection system can reduce the amount of time needed to identify a provider device to accept the transportation request.

The multi-device selection system also improves efficiency by reducing processing and bandwidth resources relative to conventional processes. For example, the multi-device selection system allows provider devices to display multiple transportation requests without expending computational resources in generating an initial match for a provider device, changing a provider to an offline mode (or otherwise cancelling the initial match), changing to an online mode, and performing an additional algorithm to generate an additional match. Thus, unlike conventional systems, the multi-device selection system provides information regarding multiple transportation requests from multiple requestor devices provider devices, thus avoiding additional queries, analysis, and computational resources from provider devices and backend servers.

Moreover, the multi-device selection system overcomes several technical barriers related to providing multiple transportation options to provider devices. For instance, the multi-device selection system intelligently utilizes screen space and functionality by tailoring which transportation requests to surface on provider devices. For example, the multi-device selection system can determine how many selectable elements to surface on a provider device interface and select transportation requests that provide a diversity of options (e.g., in distance, proximity, time, or route) that allow for improved display within the user interface. Moreover, the provider device can surface the elements on an interactive map that allows a provider device to provide accurate and sufficient information (e.g., preview the route, destination, transportation value, etc.) without requiring a provider device to glean information while comparing transportation requests through multiple interfaces. Thus, the multi-device selection system can provide pertinent information within the limited screen space of mobile devices utilizes in conjunction with a transportation matching system.

Additionally, the multi-device selection system overcomes issues concerning providing multiple transportation requests to various provider devices. For example, by surfacing individualized transportation request subsets to specific provider devices, the multi-device selection system avoids wasting computational resources. To illustrate, the multi-device selection system improves computational expenditures by surfacing transportation requests to provider device that are likely to accept the transportation request and avoiding repeated resources in rejecting and notifying numerous devices. Moreover, unlike conventional systems, the multi-device selection system intelligently addresses conflicts (e.g., overlap conditions) between provider devices. For example, upon detecting an overlap condition (e.g., multiple provider devices trying to simultaneously accept the same transportation request), the multi-device selection system can analyze features associated with each provider device and dynamically determine which provider device results in the most efficient match.

As indicated by the foregoing discussion, the present disclosure utilizes a variety of terms to describe features and advantages of the multi-device selection system. For example, as used herein, the term “provider device” refers to a computing device associated with a transportation provider or driver (e.g., a human driver or an autonomous computer system driver) that operates a transportation vehicle. For instance, a provider device refers to a mobile device such as a smartphone or tablet operated by a provider. Thus, the term “provider device” can include a computing device that places a query identifying availability to transport a requestor device from a geographic location to another geographic location. To illustrate, a requestor device can include a mobile phone, a tablet, and a computer, any of which can search for transportation matches utilizing a mobile application or a web-based application.

As used herein, the term “requestor device” refers to a device (corresponding to a requestor) that submits a request for transportation services. In particular, the term “requestor device” can include a computing device that places a query identifying a need for transportation from a geographic location to another geographic location. To illustrate, a requestor device can include a mobile phone, a tablet, and a computer, any of which can place a request utilizing a mobile application or a web-based application. After the transportation matching system matches a requestor (or a requestor device) with a provider (or a provider device), the requestor can await pickup by the provider at a predetermined pick-up location. Upon pick-up, the provider transports the requestor to a drop-off location specified in the transportation request. Accordingly, a requestor can refer to (i) a person who requests a request or other form of transportation but who is still waiting for pickup or (ii) a person whom a transportation vehicle has picked up and who is currently riding within the transportation vehicle to a drop-off location.

As used herein, the term “transportation request” refers to a query by a requestor device seeking a transportation service. In particular, a “transportation request” can refer to a request by a requestor device to a transportation matching system to match the requestor device with a provider device for transportation service. To illustrate, a transportation request can include information about features associated with the transportation request such as: a desired pickup location, a desired drop-off location, a desired pickup time, a desired drop-off time, a wait time, a transportation value, a request type, a request device rating, a number of passengers, a transportation route, luggage, and/or special considerations for the transportation.

As used herein, the term “transportation route” refers to locations, paths, segments, or directions from one geographic location to another geographic location. To illustrate, a transportation route can include a pickup location and/or drop-off location. A transportation route can also include roads, highways, paths, and/or streets utilized to travel from a pickup location to a drop-off location. Moreover, transportation routes may further include travel time, traffic information, travel distance, time of departure, or time of arrival for travel between locations.

As used herein, the term “matching probability” refers to a likelihood that a provider device accepts a transportation request. For instance, based on features associated with the transportation request, a provider device will be more or less likely to match with a transportation request. To illustrate, a matching probability may be high when a transportation request has a high transportation value, whereas the matching probability may be low when the transportation request has a low transportation value. To further illustrate, a matching probability might be higher if the transportation request pickup location is near the provider device, whereas the matching probability may be lower when the transportation request pickup location is far away from the provider device.

As used herein, the term “transportation value” refers to a score, such as a reward or cost, related to a transportation request. For instance, a transportation value can include an estimated earning or charge associated with a transportation request. Thus, for example, a transportation value can include an amount that a provider corresponding to a provider device will receive, an amount a requestor corresponding to a requestor device will pay, or a net value reflecting an analysis of overall benefits and costs corresponding to a transportation request.

As used herein, the term “multi-request transportation model” refers to a computer-implemented algorithm that identifies a plurality of transportation requests to provide to a provider device. For example, the multi-request transportation model can analyze features associated with transportation requests and features associated with a provider device to generate a matching score. Based on the matching score, the multi-request transportation model selects a plurality of transportation requests to surface to a provider device. Moreover, the multi-request transportation model also includes a computer implemented algorithm that selects a plurality of provider devices to provide the same transportation request.

As used herein, the term “single-request transportation model” refers to a computer-implemented algorithm that identifies a single transportation request to provide to a provider device (e.g., one transportation request at a time to accept or reject). For instance, the single-request transportation model assigns a single transportation request to a single provider device. The single-request transportation model can identify features associated with transportation requests and features associated with provider devices determine an optimized match between a single transportation request and provider device.

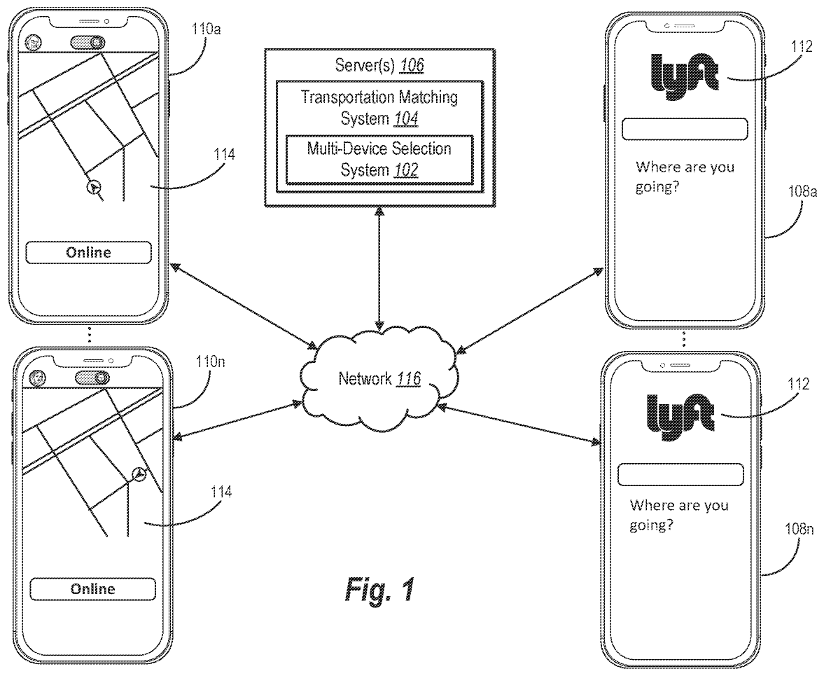

Additional detail regarding the multi-device selection system will now be provided with reference to the figures. In particular, FIG. 1, illustrates a block diagram of a system environment for implementing a multi-device selection system 102 in accordance with one or more embodiments. As shown in FIG. 1, the environment includes the server(s) 106 housing the multi-device selection system 102 as part of a transportation matching system 104. The environment of FIG. 1 further includes requestor devices 110a-110n, provider devices 108a-108n, and a network 116. The server(s) 106 can include one or more computing devices to implement the multi-device selection system 102. The requestor devices 110a-110n and/or the provider devices 108a-108n may be or comprise one or more of a variety of computing devices as described in FIGS. 11-12. Additional description regarding the illustrated computing devices (e.g., the server(s) 106, the requestor devices 110a-110n, and/or the provider devices 108a-108n) is provided with respect to FIGS. 11-12 below.

As shown, the multi-device selection system 102 utilizes the network 116 to communicate with the requestor devices 110a-110n and the provider devices 108a-108n. For example, the multi-device selection system 102 communicates with the requestor devices 110a-110n and the provider devices 108a-108n to match transportation requests received from the requestor devices 110a-110n with the provider devices 108a-108n. Indeed, the multi-device selection system 102 can track and communicate a status of the provider device 108a to provide an indicator for a location of the provider device 108a for display on a requestor device 110a as, for example, a vehicle icon within a graphical map. In some embodiments, per device settings, the multi-device selection system 102 receives device information from the requestor devices 110a-110n and the provider devices 108a-108n (e.g., via a global positioning system associated with each device) such as location coordinates (e.g., latitude, longitude, and/or elevation) and status (e.g., currently riding, not riding, available, or unavailable) for matching requests.

To facilitate connecting requests with transportation vehicles (e.g., vehicles associated with provider devices), the multi-device selection system 102 communicates with the requestor devices 110a-110n (e.g., through a requestor application 114) and the provider devices 108a-108n (e.g., through a provider application 112). As indicated by FIG. 1, the requestor devices 110a-110n include a requestor application 114, and the provider devices 108a-108n include a provider application 112. In many embodiments, the multi-device selection system 102 communicates with the requestor devices 110a-110n and the provider devices 108a-108n through the requestor application 114 and the provider application 112, respectively, to, for example, receive and provide information including transportation request information (e.g., pick-up locations and/or drop-off locations) and provider device information (e.g., provider device locations).

In some embodiments, the provider application 112 can include multiple transportation matching modes (e.g., a destination transportation matching mode or a high value transportation mode) that each correspond to different algorithms or rule sets for matching transportation requests with the provider device 108a. Additionally, the requestor application 114 and the provider application 112 optionally include computer-executable instructions that, when executed by the requestor devices 110a-110n and the provider devices 108a-108n, cause the requestor devices 110a-110n and the provider devices 108a-108n to perform certain functions as described herein.

As indicated above, the multi-device selection system 102 can provide (or cause the provider device 108a to render) visual indicators for locations associated with transportation requests. For example, in some cases, the multi-device selection system 102 selects the provider device 108a to potentially service multiple transportation requests received from various requestor devices 1010a-110n based on various factors such as a location associated with the transportation request, a provider device location, locations of other provider devices, a directional filter, an arrival time filter, provider device incentives, requestor device incentives, a time of day, traffic information, and/or other transportation matching considerations. Based on selecting the provider device 108a to service the transportation request, the multi-device selection system 102 provides a visual indicator for the transportation request for display within a user interface displayed on the provider device 108a (e.g., as part of the provider application 112).

Although FIG. 1 illustrates the environment having a particular number and arrangement of components associated with the multi-device selection system 102, in some embodiments, the environment may include more or fewer components with varying configurations. For example, in some embodiments, the multi-device selection system 102 can communicate directly with the requestor devices 110a-110n, bypassing the network 116. In these or other embodiments, the multi-device selection system 102 can be housed on and/or implemented by (entirely or in part) the provider devices 108a-108n. Additionally, the multi-device selection system 102 can include or communicate with a database for storing transportation request information, directional filter information, transportation request filter information, arrival time filter information, token information, and/or other information described herein.

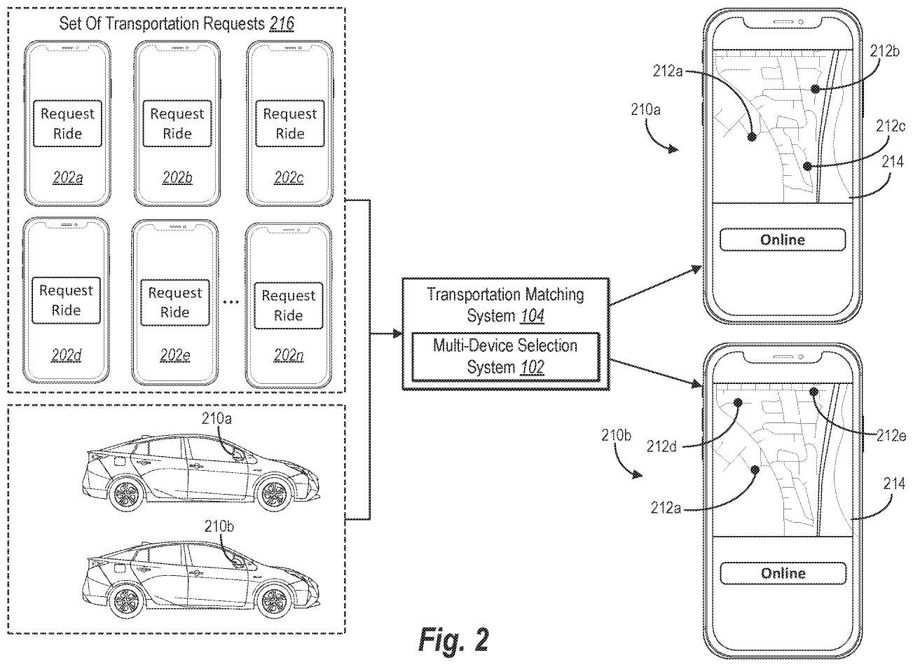

As mentioned, the multi-device selection system 102 can intelligently surface and update a subset of transportation requests within an interactive digital map to graphical user interfaces of individual provider devices. For instance, FIG. 2 illustrates the multi-device selection system 102 selecting and providing a plurality of transportation requests for display on a provider device in accordance with one or more embodiments. Specifically, FIG. 2 shows the multi-device selection system 102 receiving a set of transportation requests from a plurality of requestor devices 202a-202n and identifying information regarding a plurality of provider devices 210(a)-210b (e.g., availability, location, provider device rating, etc.). The multi-device selection system 102 identifies features associated with the requestor devices 202a-202n and the transportation requests as well as features associated with provider devices 210(a)-210(b) of transportation vehicles. The multi-device selection system 102 utilizes a multi-request transportation model to analyze the identified features and select a subset of transportation requests to surface on to provider devices 210a-210b. Once selected, the multi-device selection system 102 displays selectable elements 212a-212e representing the selected transportation requests within an interactive map 214 on the provider device 210a-210b interfaces.

As mentioned above, the multi-device selection system 102 can receive a set of transportation requests 216 from the requestor devices 202a-202n. In some embodiments, the multi-device selection system 102 extracts various features regarding the requestor devices 202a-202n and the corresponding transportation requests. For example, the multi-device selection system 102 can determine features (e.g., information) provided by the requestor device, such as desired pickup location, desired pickup time, or destination. Similarly, the multi-device selection system 102 can determine or infer features regarding the requestor devices 202a-202n and corresponding transportation requests, such as a measure of ride desirability or a measure of match probability. Similarly, the multi-device selection system 102 can identify stored/historical features associated with the requestor device, such as requestor device rating, prior transportation matches, or cancellation history.

Furthermore, in one or more embodiments, the multi-device selection system 102 can extract features associated with provider devices 210a-210b. For instance, the multi-device selection system 102 can receive current location (via a GPS system associated with the provider device), ride status, or online status from the provider devices 210a-210b. Moreover, the multi-device selection system 102 can also determine or infer features associated with a provider device 210a-210b, such as a measure of provider device matching probability or ride acceptance probability. Additionally, the multi-device selection system 102 can receive stored/historical features associated with the provider devices 210a-210b, such as driver rating, prior transportation matches, provider device preferences (e.g., from the server(s) 106).

In some embodiments, the multi-device selection system 102 determines features associated with a transportation request by monitoring interactions (or a lack of interactions) across a network of provider devices in relation to the transportation request. For example, the multi- device selection system 102 can identify whether a transportation request is ignored or cancelled by one or more provider devices. Similarly, the multi-device selection system 102 can monitor an amount of time that a transportation request is pending or an amount of elapsed time after a cancellation. In addition, the multi-device selection system 102 can identify a probability that a transportation request will be selected to create a transportation match after an initial cancellation/rejection. Similarly, the multi-device selection system 102 can identify a probability that a provider device will accept a transportation request.

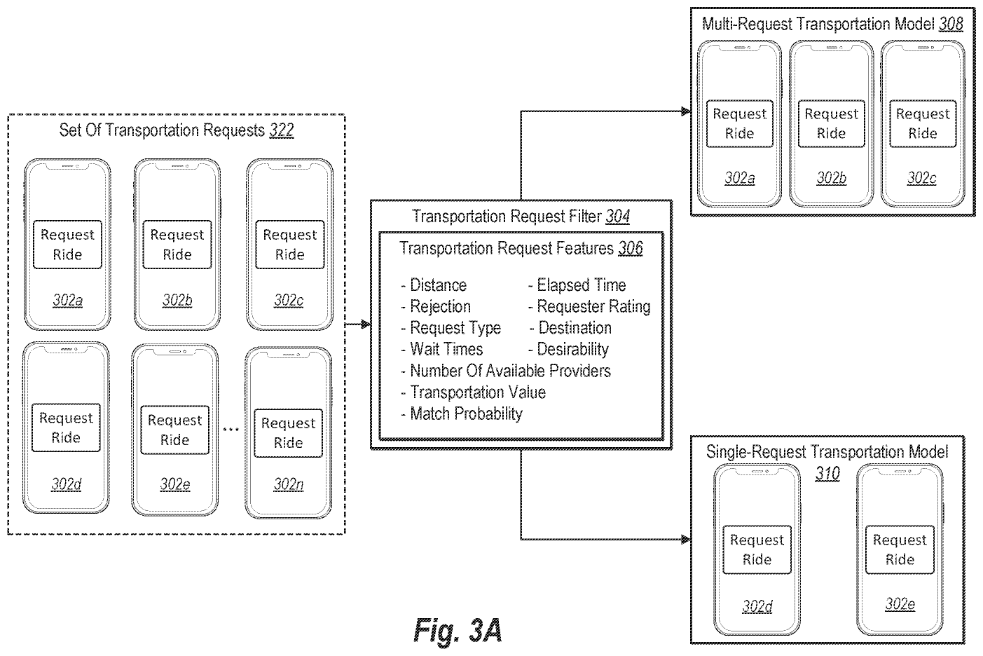

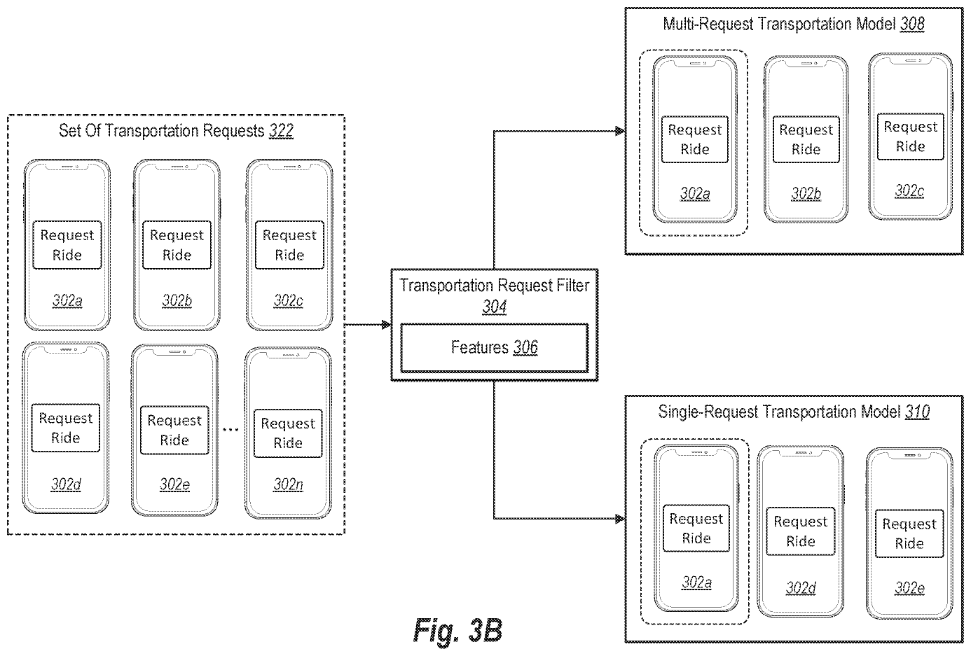

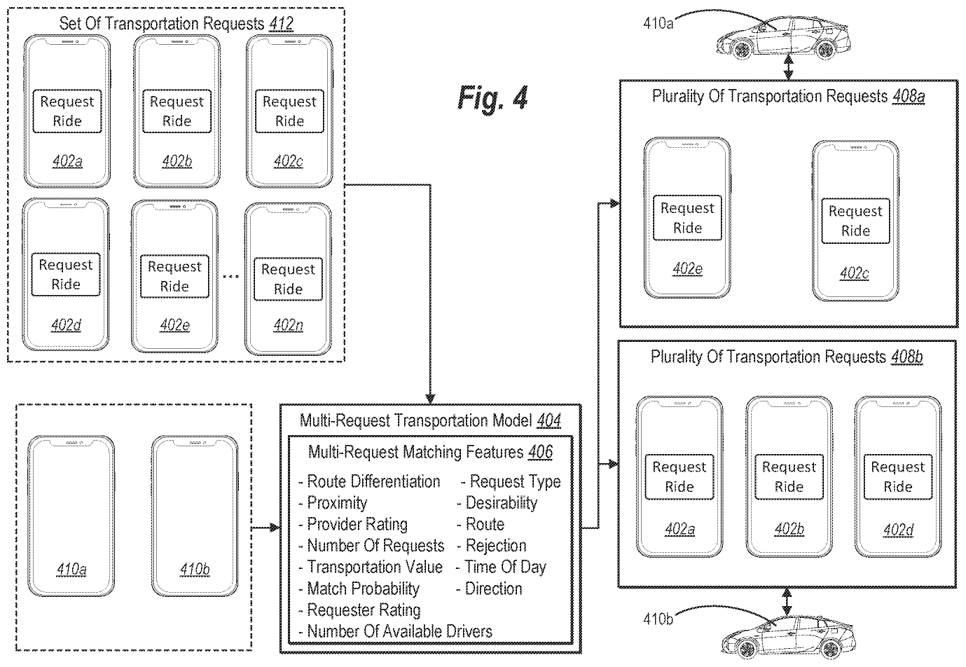

In addition to identifying features associated with transportation requests and features associated with the provider devices 210a-210b, the multi-device selection system 102 can compare the identified features to select transportation requests to surface to provider devices. In particular, in some embodiments, the multi-device selection system 102 can utilize a multi-request transportation model to analyze the identified features and generate matching scores. Based on the determined matching scores, the multi-device selection system 102 can select subsets of transportation requests to surface to the provider devices 210a-210b. For example, the multi-device selection system 102 can select to surface transportation requests corresponding to the requestor devices 202a, 202b, and 202c on the provider device 210a. More specifically, the multi-device selection system 102 can surface selectable elements 212a, 212b, and 212c, which represent transportation requests corresponding to the requestor devices 202a, 202b, and 202c, on an interactive map 214 on an interface of the provider device 210a. Further detail regarding transportation request features and provider device features will be discussed in FIGS. 3A, 3B and 4.

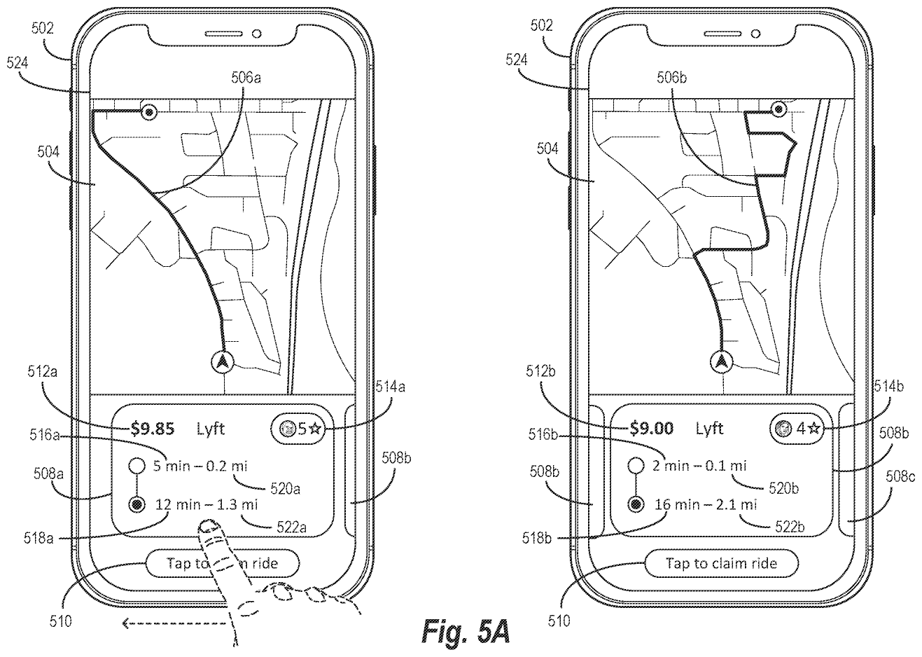

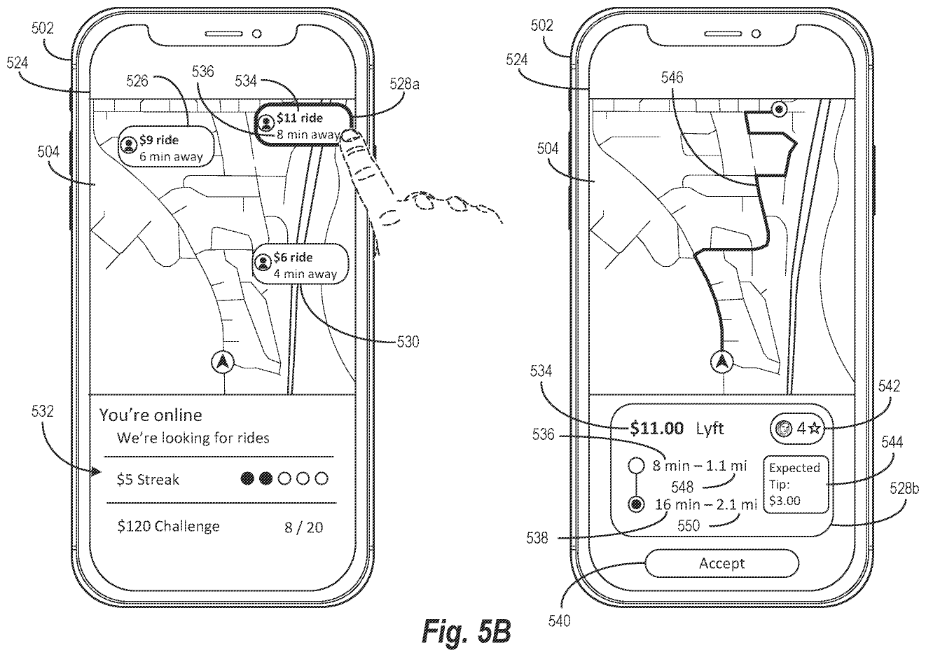

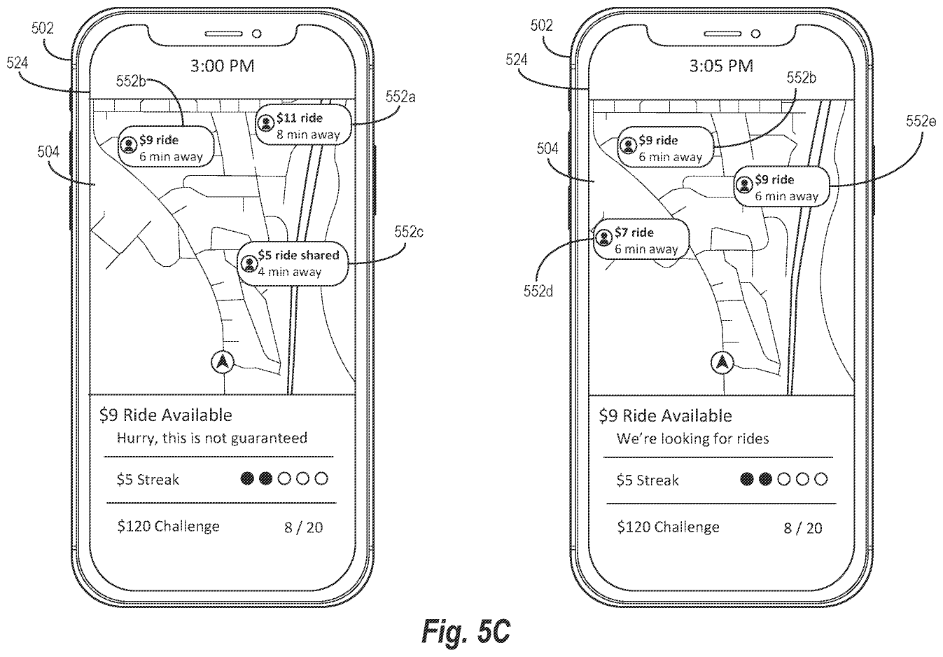

As illustrated, the multi-device selection system 102 selects and surfaces the selectable elements 212a-212c and the interactive map 214 via an interface of the provider device 210a. Additionally, the multi-device selection system 102 can dynamically update the selectable elements 212a-212e and the interactive map 214. For example, if the provider device 210b matches with the transportation request, the multi-device selection system can remove the selectable element 212a corresponding to the transportation request from an interface of another provider device. More information regarding surfacing and updating selectable elements is discussed below (e.g., in relation to FIGS. 5A-5C).

As discussed above, the multi-device selection system 102 determines whether to apply a multi-request transportation model, a single-request transportation model, or both in response to a transportation request. For example, FIGS. 3A-3B illustrate the multi-device selection system 102 utilizing a transportation request filter 304 and features 306 (e.g., transportation request features) to determine whether to funnel transportation requests for the requestor devices 302a-302n into a multi-request transportation model 308, a single-request transportation model 310, or both.

As shown in FIG. 3A, the multi-device selection system 102 receives a set of transportation requests 322 corresponding to the requestor devices 302a-302n and analyzes the transportation requests utilizing a transportation request filter 304. The transportation request filter 304 can identify features 306 and apply various computer-implemented algorithms to determine whether to apply the multi-request transportation model 308, the single-request transportation model 310, or both models to the transportation requests.

As previously mentioned, the multi-device selection system 102 can identify the features 306. The features 306 can include information related to the transportation request corresponding to the requestor device 302a. For instance, the features 306 can include, but are not limited to, a transportation route, transportation route distance, desired pickup location, desired drop-off location, desired drop-off time, desired pickup time, travel time, traffic information, cancellation/rejection history, elapsed time after cancellation/rejection, request type (e.g., group ride, multiple destination ride, specific vehicle type ride, etc.), match wait times, number of available provider devices, transportation value, desirability, match probability, and requestor device rating. The multi-device selection system 102 can identify various combinations of the features 306.

As indicated above, the multi-device selection system 102 can identify features 306 associated with a transportation route. More specifically, the multi-device selection system 102 can identify factors related to route distance, pickup location and/or time, drop-off location and/or time, travel time, and/or traffic information. For instance, in some embodiments, the multi-device selection system 102 can identify that a transportation route will encounter congested traffic, which increases travel time for a transportation request by five minutes. In other embodiments, the multi-device selection system 102 can identify the ease or difficulty of navigating to a desired pickup location. The multi-device selection system 102 can select a particular model to analyze the transportation request based on these transportation route features.

Additionally, the multi-device selection system 102 can identify features related to the rejection history of a transportation request. For example, the multi-device selection system 102 can determine if the transportation request corresponding to the requestor device 302a was matched using a different transportation matching model and whether a provider device in that transportation model rejected the transportation request. Indeed, the multi-device selection system 102 can identify when the rejection occurred and determine how much time elapsed after the rejection. For example, the multi-device selection system 102 can determine that the transportation request was rejected in a single-request transportation model and a threshold amount of time has passed (e.g., fifteen seconds). In response to these determinations, the multi-device selection system 102 can select the multi-request transportation model 308.

As previously mentioned, the multi-device selection system 102 can identify features related to request type. For instance, the multi-device selection system 102 can determine whether the transportation request corresponding to the requestor device 302a involves a standard transportation request (requesting a ride for one requestor device), shared transportation request (e.g., sharing a transportation route with other requestor devices), luxury transportation request (e.g., transporting a requestor device in a luxury vehicle), extra seats transportation request (e.g., transporting a requestor device in a larger vehicle) and/or luxury extra seats transportation request (e.g., transporting a requestor device in a larger luxury vehicle). In some embodiments, the multi-device selection system 102 can determine the request type based on receiving an indication from the requestor device. For example, in one or more embodiments, the multi-device selection system 102 can receive a transportation request where the requestor device selects a luxury ride element. The multi-device selection system 102 can select a particular model based on a transportation request type (e.g., to ensure that different modes are available across different models).

Additionally, the multi-device selection system 102 can identify features associated with a request type by determining whether a transportation request requires transportation to or from a transportation hub (e.g., airport, train station, bus station, etc.), event (e.g., concert, professional sporting event, convention, etc.) or lodging (e.g., hotel, motel, etc.). For instance, in some embodiments, the multi-device selection system 102 can determine that a transportation request type is an event pick up based on the requestor device indicating that the transportation request is picking up a requestor device from a basketball game. In other embodiments, the multi-device selection system 102 can determine the type of transportation request based on the desired pickup location. For example, the multi-device selection system 102 can determine that a transportation request is an airport transportation request based on the desired pickup location corresponding to an airport terminal address. The multi-device selection system 102 can select a particular model based on these features (e.g., to ensure that different models have a variety of different destinations/locations and/or to determine a likelihood of acceptance of various rides).

As discussed above, the multi-device selection system 102 can identify factors associated with transportation request wait times and provider device availability. For example, the multi-device selection system 102 can identify wait times for similar transportation requests, average wait times for active transportation requests, wait times for withdrawn transportation requests, wait times for transportation requests within a geographic region, and/or wait times for a specific time of day. In some embodiments, the multi-device selection system 102 identifies and/or averages wait times in a single-request transportation model and/or across multiple transportation request matching models (e.g., the multi-request transportation model 308 and the single-request transportation model 310). The multi-device selection system 102 can select a particular model based on wait times (e.g., to ensure that different models have access to similar wait times and ride quality options and/or to reduce overall wait time by selecting a particular model).

Additionally, the multi-device selection system 102 can determine the number of available provider devices (and/or a number of requestor devices). More specifically, the multi-device selection system 102 can determine how many provider devices are able to provide transportation services within a geographical area and/or the number or requestor devices in the geographical area (e.g., within a threshold distance or geohash). In some implementations, the multi-device selection system 102 determines a balance metric between the number of provider devices and the number of requestor devices. The multi-device selection system 102 can utilize the number of available provider devices/requestor devices to select a particular model (e.g., to provide additional options for provider devices in correcting device imbalances).

As previously mentioned, the multi-device selection system 102 may identify features 306 associated with transportation value. As described earlier, transportation value refers to a score, such as a reward or cost, related to a transportation request. Thus, the multi-device selection system 102 may identify potential earnings, bonuses, and/or loses. To illustrate, in some embodiments, the multi-device selection system 102 can estimate earnings for completing the transportation request corresponding to the requestor device 302a. In other embodiments, the multi-device selection system 102 can display a projected tip. The multi-device selection system 102 can utilize the transportation value to select between models (e.g., to ensure that models of similar value are available across different models).

As indicated above, the multi-device selection system 102 may identify a measure of desirability (e.g., ride desirability) corresponding to a transportation request. In particular, the multi-device selection system 102 may determine a measure of provider device desirability associated with a transportation request, such as anticipated interaction rate, anticipated value to a provider, or anticipated cancellation/rejection rate. For instance, the multi-device selection system 102 can analyze historical data to identify features indicating favorability of transportation request features (e.g., a transportation route or a destination). To illustrate, a transportation request from a requestor device with a high requestor device rating (e.g., passenger rating), high transportation value (e.g., large estimated earnings), and preferable drop-off location is highly desirable. Conversely, the multi-device selection system 102 can analyze historical data to identify unfavorable features. For example, in some embodiments, a transportation request with an inconvenient pickup time and an unfavorable drop-off location is less desirable. Additionally, in some embodiments, the multi-device selection system 102 may determine desirability based on various combinations of transportation request features described herein. The multi-device selection system 102 can select a model for a particular transportation request based on the measure of desirability (e.g., to ensure that different models have access to desirable transportation requests).

As previously discussed, the multi-device selection system 102 can determine the match probability of a transportation request. More specifically, the multi-device selection system 102 may determine the likelihood that provider devices will match with a transportation request. For instance, the multi-device selection system 102 can identify features associated with the transportation request, and based on the combination of features, the multi-device selection system 102 can determine the probability that a transportation request will result in a transportation match. For example, in some embodiments, the multi-device selection system 102 can determine, based on historical and/or contemporary data, that a transportation request with a pickup location from an airport to a nearby hotel in the evening has a high match probability. Conversely, the multi-device selection system 102 can determine that a transportation request with a long travel time and low transportation value has a lower match probability. The multi-device selection system 102 can select a model based on the match probability (or lapse likelihood). To illustrate, the multi-device selection system 102 can select transportation requests with a 25-75% lapse likelihood or acceptance rate for the multi-request transportation model 308.

As indicated above, the multi-device selection system 102 can identify features 306 related to requestor device rating. In particular, the multi-device selection system 102 can identify a grade, ranking and/or feedback about prior transportation matches associated with a requestor device. To illustrate, a requestor device rating could be a rating on a scale of one to five or a selection on a scale of very unsatisfied to very satisfied. Moreover, in one or more embodiments, feedback (e.g., written communication) about the requestor device could affect a requestor device's rating. For instance, a requestor device rating could be an average of previous ratings for a requestor device. The multi-device selection system 102 can select a model based on the requestor device rating (e.g., to ensure that a model has a certain number or percentage of transportation requests having a threshold requestor device rating).

As previously mentioned, the multi-device selection system 102 can utilize the transportation request filter 304 to determine whether to utilize the multi-request transportation model 308 and/or the single-request transportation model 310 in analyzing a transportation request. As used herein, the term “transportation request filter” refers to a computer-implemented algorithm that selects, identifies, and/or filters transportation requests (e.g., for a particular matching model). For instance, in one or more embodiments, the multi-device selection system 102 utilizes the transportation request filter to select transportation requests corresponding to the requestor devices 302a-302n for the multi-request transportation model 308 based on the features 306 identified by the multi-device selection system 102.

To illustrate, in one or more embodiments, the multi-device selection system 102 monitors a transportation request to determine when it has been rejected by one or more provider devices. For instance, the multi-device selection system 102 can determine an initial match with a provider device and detect that the provider device allows the transportation lapse (e.g., not accepted within a specific timeframe) or detect that the provider device/requestor device cancels the transportation request. In response to determining that the transportation request is rejected, the transportation request filter 304 can assign the transportation request corresponding to the requestor device 302a to the multi-request transportation model 308.

Moreover, in some implementations, the multi-device selection system 102 can utilize the transportation request filter 304 to assign transportation requests corresponding to the requestor devices 302a-302n based on a combination of a transportation request being rejected and/or an elapsed timeframe (e.g., a threshold timeframe). For example, in one or more embodiments, the transportation request filter 304 can select the multi-request transportation model 308 based on a threshold timeframe (e.g., five seconds) passing without an additional match after a provider device rejects the transportation request.

In other embodiments, the transportation request filter 304 can funnel a specific number and/or ratio (e.g., percentage) of highly desirable transportation requests into the multi-request transportation model 308. For instance, the multi-device selection system 102 can determine favorability scores for transportation requests and apply an initial threshold to determine favorable transportation request. The multi-device selection system 102 can then select a threshold amount of favorable transportation requests for a particular model. For instance, the multi-device selection system 102 can employ a ride desirability threshold, where 15% of all transportation requests in the multi-request transportation model 308 are favorable/desirable transportation requests.

As indicated above, the transportation request filter 304 can utilize various mechanisms to filter transportation requests into various transportation matching models. For instance, the transportation request filter 304 can utilize a random partition model to filter rides into a multi-request transportation model 308. For example, in some embodiments, the transportation request filter 304 can randomly select and assign ten percent of all transportation requests into the multi-request transportation model 308.

Additionally, the multi-device selection system 102 can select a matching transportation model for transportation requests based on an optimization model (e.g., a local greedy optimization model or a global optimization model). For instance, the multi-device selection system 102 can analyze the features 306 identified by the multi-device selection system 102 and direct the corresponding transportation request into the multi-request transportation model 308 or the single-request transportation model 310 to optimize a particular result or objective.

To illustrate, the multi-device selection system 102 can determine a cost/reward score corresponding to the features 306. To illustrate, the multi-device selection system 102 can determine a cost/reward value for distance travelled for transportation requests between the multi-request transportation model 308 and the single-request transportation model 310 (e.g., to ensure that requests assigned to one model are not biased according to distance). Similarly, the multi-device selection system 102 can determine a cost/reward value for wait times, transportation value, elapsed time, and destination.

Moreover, the multi-device selection system 102 can determine a difference in values corresponding to selecting the multi-request transportation model 308 and the single-request transportation model 310. For example, utilizing the multi-request transportation model 308 allows provider devices time to select transportation requests, which can slightly increase overall elapsed time. However, utilizing the multi-request transportation model 308 can also increase the overall number of provider devices (and driver experience) by providing improved user interfaces and options. The multi-device selection system 102 can utilize an optimization model to balance these competing factors.

Moreover, the multi-device selection system 102 can determine a cost/reward value regarding the number of available provider devices and/or the number of available requestor devices. For instance, the transportation matching system 104 can operate inefficiently if there is an imbalance between provider devices and requestor devices within a geographic region. Moreover, utilizing the multi-request transportation model 308 and/or the single-request transportation model 310 can either exacerbate or correct for these inefficiencies. For example, surfacing additional transportation requests via the multi-request transportation model 308 can give provider devices additional options and increase the number of provider devices operating within the transportation matching system. Thus, the multi-device selection system 102 can funnel additional transportation requests to the multi-request transportation model 308 if there is a device imbalance of too many provider devices relative to requestor devices. Conversely, if there is a device imbalance of too many requestor devices relative to provider devices, the multi-device selection system 102 can funnel additional transportation requests to the single-request transportation model 310. If the balance is relatively even, the multi-device selection system 102 can funnel a transportation request to both the multi-request transportation model 308 and the single-request transportation model 310.

The multi-device selection system 102 can also determine cost/reward values related to requester rating, desirability, request type, transportation value, and/or match probability. For example, providing an imbalance of difficult requesters, low transportation value requests, shared rides, and/or low match probability requests to the multi-request transportation model 308 and/or the single-request transportation model 310 can influence the number of provider devices willing to provide transportation requests or receive transportation matches via one of the models. Accordingly, the multi-device selection system 102 can consider and balance these factors in selection transportation requests to utilize via each model.

For example, in one or more embodiments, the multi-device selection system 102 selects an overall objective (e.g., total number of rides, total number of provider devices, or overall transportation value efficiency). The multi-device selection system 102 then determines how each of the features 306 contribute to the overall objective by assigning a score/reward corresponding to the feature. The multi-device selection system 102 then utilizes the optimization algorithm to assign the transportation requests to particular models to optimize the overall objective.

The multi-device selection system 102 can utilize a local greedy optimization model that determines scores for transportation requests and iteratively assigns the transportation requests based on the highest remaining scores. The multi-device selection system 102 can also utilize a global optimization model that analyzes the transportation requests as a whole to determine the optimal combination of assignments to improve the overall objective.

In some embodiments, transportation request filter 304 utilizes a machine learning model to analyze the features 306 identified by the multi-device selection system 102. In particular, the term “machine learning model” includes a computer algorithm or a collection of computer algorithms that can be trained and/or tuned based on inputs to approximate unknown functions. As another example, a machine learning model can include a computer algorithm with branches, weights, or parameters that change based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

In one or more embodiments the transportation request filter 304 can utilize a machine learning model to assign transportation requests to the multi-request transportation model 308 or the single-request transportation model 310. For instance, in some embodiments, the machine learning model can encode the features 306 and feed the encoded features into channels of a neural network, decision tree, or other machine learning model. The machine learning model can process the encoded features (e.g., through layers of the neural network or branches of a decision tree) to generate a predicted model to assign to the transportation request. Thus, the multi-device selection system 102 can utilize the machine learning model to assign the transportation request to the multi-request transportation model 308 and/or the single-request transportation model 310. In some implementations, the machine learning model generates a predicted result or state change (e.g., a likelihood of reduced wait time, a likelihood of improved provider device interactions, etc.) and selects the model based on the predicted result or state change.

Additionally, in certain embodiments, the multi-device selection system 102 trains or tunes a machine learning model. In particular, the multi-device selection system 102 utilizes an iterative training process to fit a transportation request filter machine-learning model by adjusting or adding decision trees or learning parameters that result in accurately filtering transportation requests into the multi-request transportation model 308. For example, the multi-device selection system 102 can generate a predicted result or state change (e.g., a predicted wait time or a predicted amount of provider device engagement based on the selected model). The multi-device selection system 102 then compares the prediction with a measured ground truth. The multi-device selection system 102 can utilize a loss function to determine a measure of loss between the predicted result and the ground truth and modify the parameters of the machine learning model based on the predicted result.

In some embodiments, the multi-device selection system 102 utilizes a reinforcement learning model, such as a Markov Decision Process. For example, the multi-device selection system 102 can utilize a transportation request filter 304 (or selection model) that includes a learner model and a decision-making (i.e., agent) model. The agent model selects an action for a given state, which an environment reacts to in transitioning to a new state with a corresponding reward. Based on historical patterns reflected in the features above, the multi-device selection system 102 can learn the probability of state changes and rewards associated with a particular action. Thus, in one or more embodiments, the multi-device selection system 102 learns the probability of a different state transitions and rewards by analyzing the historical features described above. Moreover, the transportation request filter 304 can then determine a current state and select a particular action (e.g., a model) to move to an improved state and corresponding reward. Thus, the multi-device selection system 102 can include a reinforcement learning model utilized to select a model that will improve (e.g., maximize) the probability of a particular reward or outcome (e.g., improved efficiency, reduced wait times, improved provider device utilization, or improved number of rides).

Thus, as illustrated in FIG. 3A, the multi-device selection system 102 assigns transportation requests corresponding to the requestor devices 302a-302c to the multi-request transportation model 308. In addition, the multi-device selection system 102 assigns the transportation requests corresponding to the requestor devices 302d, 302e to the single-request transportation model 310.

Indeed, the multi-device selection system 102 utilizes the multi-request transportation model 308 to generate a potential transportation match between the transportation request corresponding to the requestor device 302a and several provider devices. As previously mentioned, the multi-request transportation model 308 can further identify features associated with a transportation request and analyze those features by utilizing an optimization model (e.g., a local greedy optimization model or a global optimization model) or a machine learning model. Based on the analysis, the multi-device selection system can select which transportation requests (and how many transportation requests) to surface to which provider devices (and how many provider devices). Further detail regarding the multi-request transportation model 308 is given below (e.g., with regard to FIG. 4).

As illustrated in FIG. 3A, the multi-device selection system 102 utilizes a single-request transportation model 310 to create a transportation match between one transportation request and one provider device. As discussed above, the single-request transportation model 310 can identify features related to a transportation request and analyze those features to determine an optimum transportation match between the transportation request and a single provider device.

Although FIG. 3A illustrates the multi-device selection system 102 selecting either the multi-request transportation model 308 or the single-request transportation model 310, the multi-device selection system 102 can also utilize both models to determine a match for a particular transportation request. Indeed, as shown in FIG. 3B, the multi-device selection system 102 utilizes the transportation request filter 304 and the features 306 to select both the multi-request transportation model 308 and the single-request transportation model 310 for a particular transportation request. As discussed above the multi-device selection system 102 can identify features associated with a transportation request. As discussed above, the transportation request filter 304 can analyze various combinations of the features 306 and determine a match for a transportation request utilizing the multi-request transportation model 308 and the single-request transportation model 310.

To illustrate, in one or more embodiments, based on a transportation request desirability and drop-off location, the multi-device selection system 102 can analyze the transportation request corresponding to the requestor device 302a using a single-request transportation model 310 and a multi-request transportation model 308. In one or more embodiments, once the transportation request corresponding to the requestor device 302a is in both transportation matching models, the multi-request transportation model 308 can surface the transportation request to multiple provider devices while the single-request transportation model 310 can offer the transportation request to one provider device.

In some implementations, the multi-request transportation model 308 pulls from a pool of participating multi-request provider devices while the single-request transportation model 310 pulls from a separate pool of participating single-request provider devices. To illustrate, in one or more embodiments, the multi-device selection system 102 can surface a transportation request to a set of provider devices from the pool of participating multi-request provider devices in the multi-request transportation model 308 while concurrently surfacing the transportation request to the a provider device from the pool of single-request provider devices. The multi-device selection system 102 can then finalize the match based on which provider device selects, accepts, or confirms the transport request the fastest.

In some implementations, the multi-device selection system 102 can utilize a time buffer to provide a transportation request via a first model before utilizing a second model. For example, the multi-device selection system 102 can provide a transportation request to provider devices selected via the multi-request transportation model 308 for a time buffer (e.g., ten seconds) before providing the transportation request to a provider device selected via the single-request transportation model 310.

As mentioned, the multi-device selection system 102 can utilize a multi-request transportation model 308 and features to select which transportation requests to surface to each provider device. In particular, FIG. 4 illustrates the multi-device selection system 102 evaluating transportation requests from requestor devices 402a-402n by utilizing a multi-request transportation model 404 to analyze the features 406 associated with a transportation request.

As shown in FIG. 4, the multi-request transportation model 404 can receive a set of transportation requests 412 from several requestor devices 402a-402n. Upon receiving the transportation requests, the multi-device selection system 102 identifies and utilizes the features 406 associated with the set of transportation requests 412 and provider devices 410a-410b. The features 406 can include a variety of types of information related to transportation requests from the requestor devices 402a-402n (including those discussed above with regard to FIG. 3). For instance, the features 406 associated with a transportation request corresponding to the requestor device 402a can include, but are not limited to, a transportation route, transportation route distance, pickup location, drop-off location, drop-off time, pickup time, travel time, traffic information, rejection history, elapsed time after rejection, request type, match wait times, number of available provider devices, transportation value, a measure of desirability/favorability, match probability, requestor device rating, and/or route differentiation.

As previously mentioned, the multi-device selection system 102 can identify and utilize route differentiation features. In particular, in some embodiments, the multi-device selection system 102 can identify, compare, and/or quantify features between transportation requests. For instance, in one or more embodiments, the multi-device selection system 102 can compare the transportation routes of three transportation requests and determine the difference between pick-up location, drop-off location, and/or travel distance. Based on the differences, the multi-device selection system 102 can determine a route differentiation value (e.g., score, label, etc.) between the transportation routes. For example, the multi-device selection system 102 can surface transportation requests based on (e.g., to increase) route differentiation. For example, the multi-device selection system 102 can provide a mixture of locations, routes, and time periods for any particular provider device. This allows the multi-device selection system 102 to provide transportation requests with a variety of options to improve driver engagement and utilization. The multi-device selection system 102 can identify, compare, and/or determine differences between any combination of the features 406.

As indicated above, the multi-device selection system 102 can identify the features associated with the provider devices 410a-410b. For example, in one or more embodiments, the features 406 associated with the provider device can include, but are not limited to, provider device proximity, provider device direction, provider device rating, match probability, provider device overlap conditions, provider device interface crowding, and/or provider device availability.

For instance, in one or more embodiments, the multi-device selection system 102 can identify features related to proximity of a provider device to a desired pickup location. For example, in one or more embodiments, the multi-device selection system 102 identifies the driving distance or time (e.g., ETA) between a location of a provider device and a desired pickup location. The multi-device selection system 102 can utilize the proximity to select provider devices (e.g., select provider devices that are close to a transportation request). In some implementations, the multi-device selection system 102 provides all transportation requests with an ETA for a provider device within a threshold.

As indicated above, the multi-device selection system 102 can identify provider device rating features. In particular, the multi-device selection system 102 may identify a grade, ranking and/or feedback about prior transportation matches (e.g., from requestor devices) associated with a provider device. For instance, in one or more embodiments, a rating may be on a scale (e.g., rating provider device services on a scale of one to five). The multi-device selection system 102 can utilize the rating to select a provider device. In some implementations, the multi-device selection system 102 ranks provider devices and surfaces a transportation request to a particular number of the highest scoring provider devices (e.g., highest rated or highest match score provider devices). In some embodiments, the multi-device selection system 102 the multi-device selection system 102 ranks requestor devices and surfaces a particular number of the highest rated requestor devices/transportation requests to a particular provider device. In some embodiments, the multi-device selection system 102 only shows a threshold number of transportation requests (e.g., 5 closest rides or 5 highest rated rides).

The multi-device selection system 102 can also determine a number of provider devices (e.g., capacity of provider devices). The multi-device selection system 102 can select provider devices based on this available capacity. For instance, the multi-device selection system 102 can select provider devices with the highest scores/ratings subject to capacity constraints. For instance, if each provider can have at most m rides and each transportation request can be shown to at most n rides, then for each ride, the multi-device selection system 102 can assign it to the highest scoring driver not at capacity (until either the transportation request has n drivers, or no drivers remain).

As previously discussed, the multi-device selection system 102 can identify a match probability. For instance, as mentioned above, a match probability includes a likelihood that a provider device will accept a transportation request. In particular, in one or more embodiments, based on features associated with the transportation request and/or historical data corresponding to previous transportation matches, the multi-device selection system 102 can calculate a likelihood that a provider device will accept the transportation request. For example, in one or more embodiments, based on a desired pickup location, travel distance, and/or ride value and an acceptance history, the multi-device selection system 102 can determine that a provider device is 50% likely to accept a transportation request. The multi-device selection system 102 can utilize the match probability to select a provider device (e.g., select provider devices that increase a match probability and/or to stay within a total combined match probability).

The multi-device selection system 102 may utilize and/or analyze any number of the features 406 to calculate a match probability. For instance, in one or more embodiments, based on the time of day, location, requestor device rating, and/or drop-off location, the multi-device selection system 102 may identify that a provider device is 20% likely to accept a transportation request. As another illustration, in one or more embodiments, the multi-device selection system 102 can determine the match probability related to a single transportation request for multiple provider devices. For instance, in one or more embodiments, based on the features 406, one provider device may be 30% likely to accept a transportation request, while a different provider device may be 70% likely to accept the same transportation request.

Additionally, the multi-device selection system 102 can identify, calculate, and/or determine a match probability for a provider device in relation to multiple transportation requests. Additionally, the multi-device selection system 102 can identify potential provider device overlap conditions (e.g., tie breaks). A provider device overlap condition can include one or more provider devices attempting to accept the same transportation request. To illustrate, in one or more embodiments, if one provider device is 80% likely to accept a transportation request and a second provider device is 75% likely to accept the same transportation request, the multi-device selection system 102 can determine that there is a high likelihood of an overlap condition between the provider devices. Based on the high likelihood of an overlap condition, the multi-device selection system 102 can avoid the overlap condition by avoiding surfacing the transportation request to both devices.

Moreover, in one or more embodiments, the multi-device selection system 102 can determine the likelihood of an overlap condition between two or more provider devices. In particular, in one or more embodiments, the multi-device selection system 102 can determine potential provider device overlap conditions based on the features 406 and historical transportation match data. To illustrate, in one or more embodiments, based on a desired drop-off location, transportation route, and historical features associated with prior transportation matches, the multi-device selection system 102 can determine the likelihood that both provider devices 410a-410b will accept the transportation request. In one or more embodiments, the multi-device selection system 102 can predict overlap conditions for any transportation request between any provider devices 410a-410b.

As mentioned above, the multi-device selection system 102 can identify provider device interface crowding features. For instance, the multi-device selection system 102 can determine the number of transportation requests to surface on space available within an interface to avoid overcrowding. As previously discussed, the multi-device selection system 102 can efficiently surface transportation requests so that a provider device interface can quickly and accurately display transportation requests. In one or more embodiments, the multi-device selection system 102 can identify the model, screen size, clarity and/or components of a provider device. For example, in one or more embodiments, based on a provider device having a large graphical user interface, the multi-device selection system 102 can determine to surface four transportation requests on the provider device.

As further shown in FIG. 4 and previously discussed, the multi-device selection system 102 can utilize the multi-request transportation model 404. In particular, the multi-device selection system 102 can utilize the multi-request transportation model 404 to select a number of provider devices to receive a transportation request, a number of transportation requests to surface to a provider device, and particular provider devices to receive particular transportation requests. Similar to the transportation request filter 304, the multi-device selection system 102 can utilize a variety of computer-implemented models, including heuristic models, optimization (objective) models, and/or machine learning models (e.g., neural networks or reinforcement learning).

For example, the multi-device selection system 102 can utilize a heuristic model. To illustrate, in one or more embodiments, the multi-device selection system 102 can surface transportation requests within a geographic region to provider devices within a certain distance and/or time in relation to a pickup location of a transportation request. The multi-device selection system 102 can utilize a variety of triggering rules or thresholds to surface transportation requests. For example, the multi-device selection system 102 can surface a threshold number of nearest transportation requests, a number of highly-rated requests, or a number of transportation requests that satisfy a route diversity threshold (or other trigger/rule variations as described herein).

In some embodiments, the multi-device selection system 102 can surface transportation requests based on match probability. To illustrate, in one or more embodiments, the multi-device selection system 102 can surface a transportation request to provider devices so that their aggregate match probability does not exceed a threshold (e.g., 100%). For example, the multi-device selection system 102 can surface a transportation request to five provider devices if the sum of their match probabilities is below one (or 100%).

In some embodiments, based on match probability, overlap condition likelihood, and/or other features, the multi-device selection system 102 can stagger surfacing transportation requests to provider devices. For example, the multi-device selection system 102 can surface a transportation request to a first provider device at a first time (e.g., based on a higher score or rating). The multi-device selection system 102 can wait a period of time (e.g., 10 seconds) and then surface the transportation request to a second provider device at a second time.

As another example, in one or more embodiments, the multi-device selection system 102 can select provider devices such that a certain number or ratio (or percentage) of transportation requests surfaced to a provider device are desirable and/or have a high transportation value.

Additionally, in other embodiments, the multi-device selection system 102 can utilize a scoring system to surface transportation requests to provider devices. The scoring system can be based on one or more identified features and/or combination of features associated with a transportation request. For instance, in one or more embodiments, the multi-device selection system 102 can surface transportation requests based on the requestor device rating. To illustrate, in one or more embodiments, the multi-device selection system 102 could surface transportation requests for requestor devices with a requestor device rating over a specific threshold. In other embodiments, the multi-device selection system 102 could surface transportation requests based on a composite score of combined features. Additionally, the multi-device selection system 102 can generate a composite score for any combination of features. For example, the multi-device selection system 102 can calculate a composite score for transportation requests based on the requestor device rating and transportation value. For instance, in one or more embodiments, the multi-device selection system 102 can surface transportation requests that have composite score above a specified threshold.

Relatedly, the multi-device selection system 102 can utilize a score system to determine which transportation requests to surface to which provider devices. For instance, in some embodiments, the multi-device selection system 102 multi-device selection system 102 can surface transportation requests to provider devices that have provider device ratings that are similar to the requestor device rating. Additionally, the multi-device selection system 102 can surface transportation requests to provider devices with a provider device rating over a certain threshold.

As previously indicated, the multi-request transportation model 404 can include an optimization model. In particular, the multi-device selection system 102 can utilize the optimization model to select which (and how many) transportation requests to surface to which (and how many) provider devices. For instance, the multi-device selection system 102 can determine a cost/reward corresponding to the features 406 and utilize an optimization model to distribute the transportation requests to provider devices in a manner that will improve (e.g., maximize or optimize) an overall objective function.

Thus, for example, the multi-device selection system 102 can utilize an objective function that has a cost/reward for reducing wait times/ETAs, reducing travel time for requestor devices, increasing route differentiation, satisfying requester needs/demands (such as quick matches), satisfying provider needs/demands (access to high-quality, high-value rides with low down-times), increasing rating differentiation, increasing match probability (probability of acceptance), increasing total number of rides, reducing cancellations, decreasing screen crowding, or increasing provider device utilization. For example, the multi-device selection system 102 can assign transportation request to provider devices in a manner that will increase a total value associated with these various features/factors/objectives.

As discussed above, in some implementations, the multi-device selection system 102 utilizes a local greedy optimization algorithm. For example, the multi-device selection system 102 can determine scores for assigning various transportation requests to various provider devices. The multi-device selection system 102 can assign the transportation requests based on the scores (e.g., in descending order). This approach can result in intelligently assigned requests (and can improve computational efficiency), but may not provide an overall optimal solution.

Accordingly, in some implementations, the multi-device selection system 102 utilizes a global optimization model. For example, the multi-device selection system 102 can determine an overall combination of transportation requests and provider devices that will provide an improved (e.g., optimal) solution across all requests. Thus, the multi-device selection system 102 can analyze multiple combinations of transportation requests at multiple provider devices and select the combination that results in the optimal overall result.

In some implementations, the multi-device selection system 102 utilize an optimized score with capacity constraints the depend on individual lapse likelihoods. Let p_ij be the probability that provider devices i accepts transportation request j and let x_ij be the indicator variable of whether transportation request j is shown to provider device i. A fixed capacity constraint would have the form sum_i x_ij<=n. The multi-device selection system 102 can utilize a formulation, such as sum_i p_ij x_ij<=n. Using this formulation, the expected number of provider devices who accept the transportation request is at most n. A natural value of n could be 1.

In addition to an optimization model (e.g., an objective function), the multi-device selection system 102 can also utilize and train a machine learning model to determine which transportation requests to surface on provider devices. For instance, the multi-request transportation matching machine learning model generates encodings of the features 406 and analyzes the features utilizing the machine learning model to determine where to surface a transportation request. For example, the machine learning model can predict one or more performance metrics, results, or outcomes (e.g., interaction probability, transportation value, number of rides, overall transportation value) associated with providing a transportation request to a provider device. The multi-device selection system 102 can utilize the predicted performance metric to surface transportation requests to provider devices. For example, the machine learning model can generate a predicted probability of a particular result. The multi-device selection system 102 can surface transportation requests based on the predicted probability (e.g., the transportation requests with the highest probability and/or the transportation requests that satisfy a threshold probability). Thus, as shown in FIG. 4, the multi-device selection system 102 can surface a plurality of transportation requests 408b (e.g., three different transportation requests) to provider device 410b while surfacing another plurality of transportation requests 408a (e.g., two different transportation requests) to another provider device 410a.

As indicated above, in certain embodiments, the multi-device selection system 102 trains or tunes a machine learning model. In particular, the multi-device selection system 102 utilizes an iterative training process to fit a machine learning model to historical training data. For example, the multi-device selection system 102 can utilize a machine learning model to generate a predicted result and utilize a loss function to compare the predicted result with a ground truth result. The multi-device selection system 102 can then modify parameters of the machine learning model based on the measure of loss generated from utilizing the loss function. In this manner, the multi-device selection system 102 can train a machine learning model to accurately align transportation requests and provider devices.

As discussed above with regard to FIG. 3, the multi-device selection system 102 can also utilize a reinforcement learning model, such as a Markov Decision process, to select transportation requests to surface to provider devices. In particular, the multi-device selection system 102 can determine a current state and select transportation requests to provide to provider devices to move to a subsequent state that will improve a particular reward.

In some implementations, the multi-request transportation model 404 is combined with the transportation request filter 304. Indeed, as described in relation to FIG. 3, the multi-device selection system 102 can utilize similar models to select the multi-request transportation model 308 and the single-request transportation model 310. In some implementations, the multi-device selection system 102 utilizes a combined model to assign a transportation request to the multi-request transportation model 308 and also select which provider devices will receive a subset of transportation requests. Thus, the description of features and algorithms discussed in relation to the transportation request filter 304 of FIG. 3 can also apply to the multi-request transportation model 404.

As mentioned above, the multi-device selection system 102 can dynamically modify user interfaces of provider devices. In particular, in one or more embodiments, the multi-device selection system 102 can update selectable elements associated with transportation requests on provider devices based on various events. For example, in one or more embodiments, the multi-device selection system 102 may update a user interface of a provider device if a transportation request is matched with another provider device (or a transportation request is cancelled). In some embodiments, the multi-device selection system 102 can update provider device interfaces if a new and/or more optimal transportation request becomes available. Additionally, in other embodiments, the multi-device selection system 102 can update selectable elements on a user interface based on changes in location of a provider device and/or the passage of time.

In some implementations, the multi-device selection system 102 iteratively performs the analysis of FIGS. 3 and 4 over time to surface and modify transportation requests at provider devices. For example, the multi-device selection system 102 can repeatedly analyze transportation requests at a certain frequency (e.g., every 4 seconds or every 10 seconds) to assign transportation requests to provider devices. In some implementations, the multi-device selection system 102 includes a threshold display time for transportation requests at provider devices (e.g., to avoid confusion as options change too quickly). Thus, for example, the multi-device selection system 102 will display a transportation request for at least 15 seconds before removing the transportation request from a display.

As discussed above, the multi-device selection system 102 may intelligently surface a plurality of transportation requests to provider device interfaces. In particular, the multi-device selection system 102 can surface a customized plurality of transportation requests to each provider device interface. FIGS. 5A-5C illustrate various examples of provider device interfaces displaying selectable elements indicating a plurality of transportation requests in accordance with one or more embodiments.

For example, in FIG. 5A, the multi-device selection system 102 displays an interactive map 504, selectable elements 508a-508c indicating a plurality of transportation requests, and transportation routes 506a-506b associated with transportation requests on a provider device interface 524. In one or more embodiments, the selectable element 508a indicating a transportation request can include information about the transportation request such as: the transportation route 506a overlaid on the interactive map 504, a transportation value 512a, an estimated time of arrival at a pickup location 516a, a travel distance to a pickup location 520a, an estimated time of arrival to drop-off location 518a, a travel distance to a drop-off location 522a, and/or a requestor device rating 514a. Additionally, the multi-device selection system 102 can display a claim ride element 510 for provider devices to accept a transportation request. In some embodiments, the multi-device selection system 102 can display any number and/or combination of multi-request features (e.g., information) associated with a transportation request within the selectable element 508a indicating the transportation request.

As further indicated in FIG. 5A, the multi-device selection system 102 receives a selection (e.g., swiping, tapping, double tapping, pressing, etc.) via the provider device 502. For instance, the multi-device selection system 102 can receive input indicating a horizontal (e.g., left-to-right or right-to-left), vertical (e.g., up and down) or diagonal (e.g., corner-to-corner) swiping motion on the provider device interface 524. In response to receiving a horizontal swiping motion, the multi-device selection system 102 can further display a second selectable element 508b indicating a second (e.g., different) transportation request. In one or more embodiments, the second selectable element 508b can include information associated with the second transportation request such as: a transportation route 506b overlaid on the interactive map 504, a transportation value 512b, an estimated time of arrival at a pickup location 516b, a travel distance to a pickup location 520b, an estimated time of arrival to a drop-off location 518b, a travel distance to a drop-off location 522b, and/or a requestor device rating 514b. In some embodiments, a provider device 502 may navigate (e.g., swipe) through any number of selectable elements indicating transportation requests.

Additionally, in one or more embodiments, as the provider device 502 navigates (e.g., swipes, taps, double taps, presses, etc.) through the selectable elements 508a-508c indicating transportation requests, the interactive map 504 can change (e.g., zoom in, zoom out, rotate, display different geographic areas, view angle, etc.) based on the surfaced transportation routes. As indicated above, in some embodiments, when the multi-device selection system 102 receives a selection of a claim ride element 510 and forms a transportation match, the multi-device selection system 102 can send navigation instructions to the provider device to the pickup location.

As indicated above, FIG. 5B provides an alternative example of a provider device interface 524 displaying selectable elements 526, 528a, 530 indicating a plurality of transportation requests on the interactive map 504. For instance, FIG. 5B shows an embodiment with selectable elements 526, 528a, and 530 indicating three different transportation requests on the interactive map 504. Moreover, FIG. 5B further displays provider device information 532 (e.g., ride streak, online status, and/or challenge standing). In one or more embodiments, the selectable elements can include a variety of features. For instance, in some embodiments, the selectable elements can include requestor device rating and/or travel distance to a desired pickup location.

As previously mentioned, in one or more embodiments, the multi-device selection system 102 can receive a selection (e.g., swiping, tapping, double tapping, pressing, etc.) from the provider device 502. As further shown in FIG. 5B, the multi-device selection system 102 can receive a selection (e.g., tap) of the selectable element 528a indicating a transportation request. In some embodiments, based on the selection (e.g., tap), the multi-device selection system 102 can surface and/or overlay additional information related to the transportation request on the interactive map 504. In particular, the multi-device selection system 102 can display a transportation route 546, a selectable accept element 540, and an information element 528b with information about the transportation request. For example, the multi-device selection system 102 can display a transportation value 534, an estimated time of arrival at a pickup location 536, a travel distance to a pickup location 548, an estimated time of arrival to a drop-off location 538, travel distance to a drop-off location 550, a requestor device rating 542, and/or an expected tip 544.

In one or more embodiments, once the multi-device selection system 102 receives input of a provider device 502 selecting the selectable accept element, the multi-device selection system 102 can provide navigation instructions to the pickup location.

As discussed above, the multi-device selection system 102 can dynamically update selectable elements associated with transportation requests. FIG. 5C shows the multi-device selection system 102 updating selectable elements 552a-552e on a provider device interface 524 in accordance with one or more embodiments.

For instance, as shown in FIG. 5C, the multi-device selection system 102 can update selectable elements corresponding to a transportation request. To illustrate, the multi-device selection system 102 can keep, remove, update, and/or replace selectable elements based on changing circumstances. For instance, based on a first provider device accepting a transportation request corresponding to selectable element 552a and a requestor device withdrawing a transportation request associated with selectable element 552c, the multi-device selection system 102 can remove selectable elements 552a and 552c and replace them with selectable elements 552d and 552e that each correspond to additional transportation requests. As further shown in FIG. 5C, the multi-device selection system 102 can remove and/or replace selectable elements 552a, 552c-552e while maintaining selectable element 552b. Moreover, the multi-device selection system 102 may keep, remove, update, and/or replace selectable elements 552a-552e based on any combination of changed circumstances.

Additionally, in one or more embodiments, the multi-device selection system 102 can update several provider device interfaces based on a change (e.g., acceptance, withdrawal, alteration) to a transportation request. To illustrate, in one or more embodiments, the multi-device selection system 102 surfaces a selectable element 552a corresponding to a transportation request to five provider devices. If one of the five provider devices accepts the transportation request, the multi-device selection system 102 can remove selectable element 552a from the interface of the four additional provider devices. Moreover, based on identified multi-request features, the multi-device selection system 102 can determine to replace the selectable element 552a with one or more additional selectable elements corresponding to additional transportation requests.

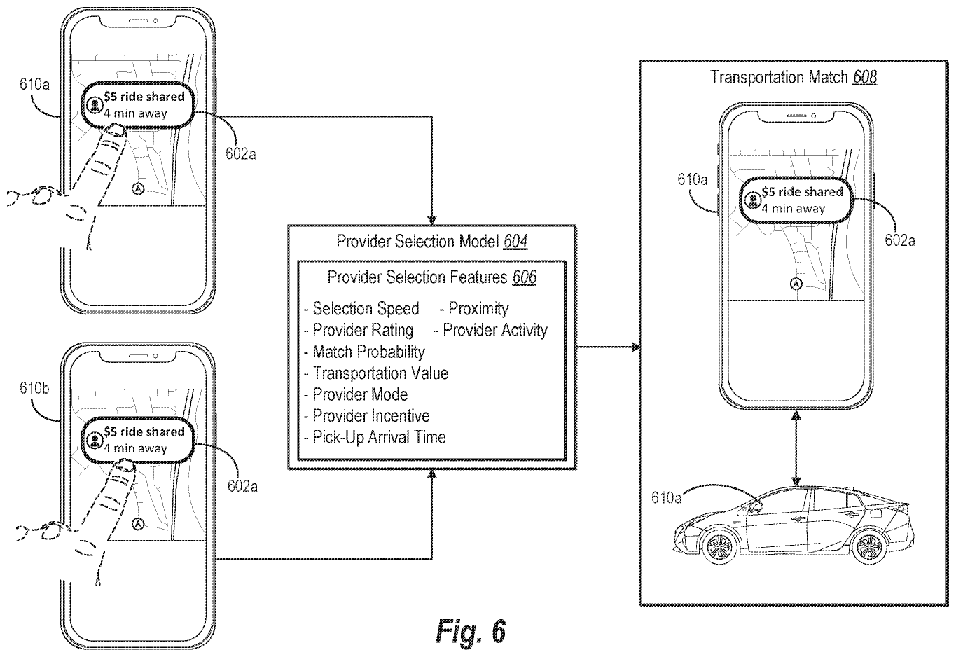

As indicated above, the multi-device selection system 102 can avoid and/or resolve overlap conditions (e.g., two or more provider devices accepting the same transportation request) between multiple provider devices. FIG. 6 shows the multi-device selection system 102 resolving overlap conditions between provider devices in accordance with one or more embodiments.

As shown in FIG. 6 the multi-device selection system 102 can utilize a provider selection model 604 and features 606 to settle an overlap condition between two or more provider devices. In particular, in one or more embodiments, when a provider device 610a and an additional provider device 610b select and/or accept the same selectable element 602a corresponding to a transportation request, the multi-device selection system 102 can decide which provider device 610a-610b will match with the transportation request. In one or more embodiments, the multi-device selection system 102 can determine which provider device 610a-610b matches with the transportation request by identifying features 606 and analyzing the features 606 with a provider selection model 604.

As mentioned above, the multi-device selection system 102 can identify the features 606 (e.g., the features 306, 406 as described above). In one or more embodiments, provider selection features can include, but are not limited to, provider device rating, match probability, transportation value, estimated time of arrival at a pickup location, provider device proximity, selection speed, provider device activity, provider device mode, and/or provider device incentive. As previously indicated, the multi-device selection system 102 can identify features associated with selection speed of a provider device. In particular, in one or more embodiments, the multi-device selection system 102 can identify when a provider device 610a selects and/or accepts a selectable element corresponding to a transportation request. For instance, in some embodiments, the multi-device selection system 102 can determine which provider device accepts a transportation request first. Moreover, the multi-device selection system 102 can select the provider device based on the order or speed in which they selected the transportation request.

As indicated above, the multi-device selection system 102 can identify features 606 associated with provider device activity. For instance, in one or more embodiments, identifying provider device activity can include identifying prior transportation matches, expended time on prior transportation services, online and/or offline status, and/or periods of time when a provider device is most active (e.g., time range when provider device makes the most transportation matches). For instance, in one or more embodiments, the multi-device selection system 102 can identify whether a provider device 610a is increasing or decreasing use of the multi-device selection system 102. In particular, in some embodiments, the multi-device selection system 102 can determine whether a provider device 610a is spending more time in a multi-request transportation model and/or single-request transportation model. Additionally, the multi-device selection system 102 can identify and/or determine trends associated with provider device activity. For example, in some embodiments, the multi-device selection system 102 can determine that a provider device 610a is consistently spending more time providing transportation services on the transportation matching system at a certain time of day. The multi-device selection system 102 can select a provider device to receive a transportation request to further improve utilization of the multi-device selection system 102 (e.g., based on a provider device being a new user of a multi-request feature or a trending decrease in utilization of the multi-request feature).

As previously mentioned, the multi-device selection system 102 can identify features associated with a provider device mode. For instance, in one or more embodiments, the multi-device selection system 102 can determine whether a provider device 610a is offering standard transportation services (e.g., providing transportation services for one requestor device), shared transportation services (e.g., providing transportation services for requestor devices sharing the transportation service), luxury transportation services (e.g., providing transportation services in a luxury vehicle), extra seats transportation services (e.g., providing transportation services in a larger vehicle) and/or luxury extra seats transportation services (e.g., providing transportation services in a larger luxury vehicle). In some embodiments, the multi-device selection system 102 can determine the provider device mode based on receiving an indication from the provider device 610a. For example, in one or more embodiments, the requestor device can inform the multi-device selection system 102 that they only provide luxury transportation services. The multi-device selection system 102 can select a provider device based on whether the current transportation mode aligns with the selected transportation request. In some implementations, the multi-device selection system 102 selects a provider device with a transportation mode that does not align to the features of the transportation request (e.g., to encourage the provider device to provide transportation services beyond a current, limited eligibility transportation mode).

Additionally, the multi-device selection system 102 can identify features associated with provider device incentives. For instance, in some embodiments, incentives can include, but are not limited to, priority in the provider selection model 604 (e.g., preference and/or higher likelihood of receiving high value transportation requests when an overlap condition occurs), bonuses (e.g., ride streaks, bonus zones, streak zones, etc.), earnings guarantees (e.g., ensured earnings for completing transportation matches), and/or upfront tipping (e.g., confirmed tip from requestor device). Moreover, in one or more embodiments, based on features associated with a provider device, the multi-device selection system 102 can determine when and/or how to incentivize the provider device. For instance, in one or more embodiments, if a provider device is not utilizing the multi-request transportation model, the multi-device selection system 102 can guarantee earnings for transportation requests within the multi-request transportation model to the provider device. In addition, the multi-device selection system 102 can select provider devices in accordance with the preferences or other incentives selected for a provider device.

As previously discussed, the multi-device selection system 102 can identify features 606 and utilize the provider selection model 604 to analyze those features when an overlap condition arises between provider devices. In one or more embodiments, when an overlap condition occurs, the multi-device selection system 102 can utilize various algorithms to determine which provider device will match with the transportation request.

In some embodiments, the multi-device selection system 102 utilizes a heuristic model and/or rule set to resolve and/or avoid overlap conditions. For instance, in one or more embodiments, the multi-device selection system 102 may form a transportation match 608 based on selection speed. To illustrate, in one or more embodiments, the provider device with the fastest selection speed matches with the transportation request. In other embodiments, the provider device with the highest provider device rating that accepts the transportation request within a specified time will match with the transportation request. As another example, in one or more embodiments, the multi-device selection system 102 may resolve an overlap condition based on proximity of a provider device to the transportation request. For instance, if an overlap condition occurs, the provider device that is closest to the pickup location will match with the transportation request.

In other embodiments, the multi-device selection system 102 may resolve overlap conditions by utilizing an optimization method (e.g., a local greedy optimization model or a global optimization model) to analyze the identified provider selection features. For example, in one or more embodiments, the provider selection algorithm may analyze provider device rating, match probability, and/or provider device incentives to generate a provider selection value. Based on the provider selection value, the multi-device selection system 102 may match a provider device 610a with a transportation request.

As another illustration, in one or more embodiments, the multi-device selection system 102 can utilize a provider selection machine learning model to analyze identified features. For example, in one or more embodiments, the provider selection machine learning model can analyze transportation value, provider device proximity, and/or provider device mode to determine which provider device should match with the transportation request. As previously indicated, the multi-device selection system 102 can train the provider selection machine learning model. In particular, the multi-device selection system 102 utilizes an iterative training process to fit a provider selection machine-learning model by adjusting or adding decision trees or learning parameters that result in efficiently resolving provider device overlap conditions.

In one or more embodiments, when an overlap condition arises, the provider selection algorithm and/or provider selection machine learning model can analyze any number and/or combination of features 606 to determine which provider device 610a-610b to match with a transportation request.

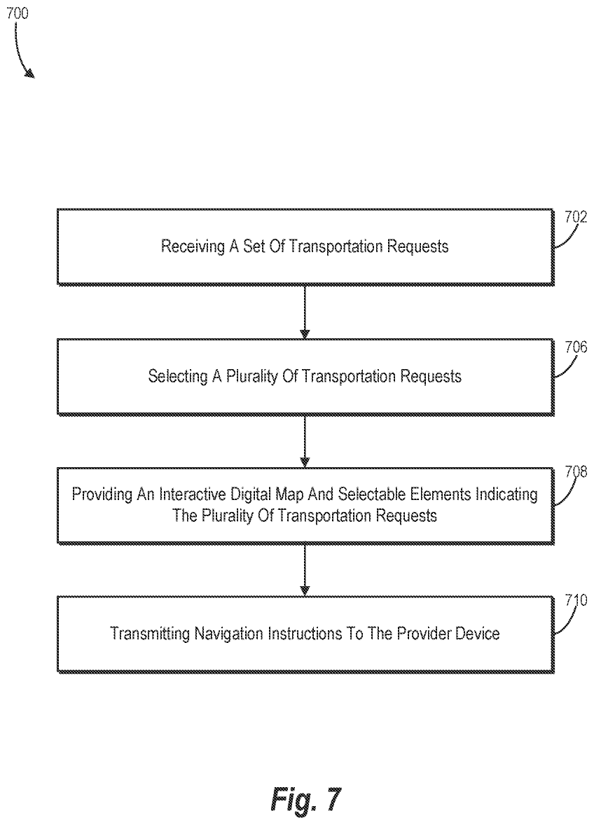

FIGS. 1-6, the corresponding text, and the examples provide a number of different methods, systems, devices, and non-transitory computer-readable media of the multi-device selection system 102. In addition to the foregoing, one or more embodiments can also be described in terms of flowcharts comprising acts for accomplishing a particular result, as shown in FIG. 7. FIG. 7 May be performed with more or fewer acts. Further, the acts may be performed in differing orders. Additionally, the acts described herein may be repeated or performed in parallel with one another or parallel with different instances of the same or similar acts.

As shown in FIG. 7, the series of acts 700 includes acts 702-710 or receiving a set of transportation requests; selecting a plurality of transportation requests; providing an interactive digital map and selectable elements indicating the plurality of transportation requests; and transmitting navigation instructions to the provider device.

For example, in one or more embodiments, the acts 702-710 include receiving, at a transportation matching system, a set of transportation requests from requestor devices 702; selecting a plurality of transportation requests from the set of transportation requests to provide to a provider computing device by comparing transportation routes for the set of transportation requests to a location of the provider computing device 706; providing, for display on the provider computing device, an interactive digital map and selectable elements indicating the plurality of transportation requests 708; and in response to receiving a selection of a selectable element of the selectable elements, transmitting navigation instructions to the provider computing device to a pickup location of a transportation request corresponding to the selectable element 710.

For example, in some embodiments, the series of acts 700 further includes selecting a set of provider computing devices to receive the transportation request, the set of provider computing devices comprising the provider computing device and an additional provider computing device.

Moreover, in some implementations, the series of acts 700 further includes providing the selectable element indicating the transportation request for display via the provider computing device; and providing an additional selectable element indicating the transportation request for display via the additional provider computing device.

In some implementations, the series of acts 700 further includes providing the additional selectable element indicating the transportation request for display with an additional interactive digital map and additional selectable elements indicating an additional plurality of transportation requests via the additional provider computing device.

Further, in one or more embodiments, the series of acts 700 further includes determining matching probabilities for provider computing devices; and selecting a number of provider devices in the set of provider computing devices to receive the transportation request based on the matching probabilities.

In addition, in some implementation, the series of acts 700 further includes in response to receiving the selection of the selectable element via the provider computing device, removing the additional selectable element indicating the transportation request from the additional provider computing device.

For example, in some embodiments, the series of acts 700 further includes selecting between a multi-request transportation model and a single-request transportation model based on an elapsed time corresponding to the transportation request; and utilizing the multi-request transportation model to select the plurality of transportation requests to provide to the provider computing device.

In some implementations, the series of acts 700 further includes providing the selectable elements for display on the provider computing device by providing a plurality of pickup location indicators and a plurality of transportation values corresponding to the plurality of transportation requests

In other embodiments, the series of acts 700 further includes, providing, for display via the interactive digital map, a first route corresponding to a first transportation request of the plurality of transportation requests; and in response to selection of the selectable element, providing, for display via the interactive digital map, a second transportation route corresponding to the transportation request.

Embodiments of the present disclosure may comprise or utilize a special purpose or general purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or generators and/or other electronic devices. When information is transferred, or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface generator (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In one or more embodiments, computer-executable instructions are executed on a general purpose computer to turn the general purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program generators may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

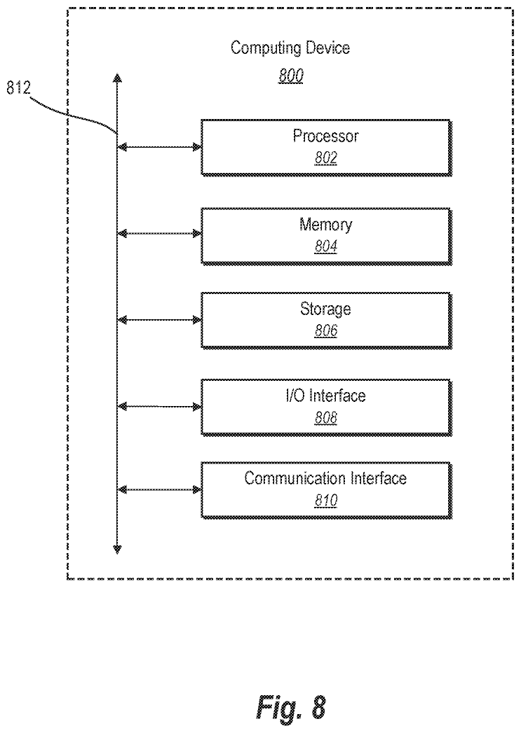

FIG. 8 illustrates a block diagram of an example computing device 800 that may be configured to perform one or more of the processes described above. One will appreciate that one or more computing devices, such as the computing device 800 may represent the computing devices described above (e.g., the server(s) 106, the provider devices 108a-108b, or the requestor devices 110a-110n). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 8, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes the memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes the storage device 806 for storing data or instructions. As an example, and not by way of limitation, the storage device 806 can include a non-transitory storage medium described above. The storage device 806 may include a hard disk drive (“HDD”), flash memory, a Universal Serial Bus (“USB”) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include the bus 812. The bus 812 can include hardware, software, or both that connects components of computing device 800 to each other.

Each of the components of the multi-device selection system 102 can include software, hardware, or both. For example, the components can include one or more instructions stored on a computer-readable storage medium and executable by processors of one or more computing devices, such as a client device or server device. When executed by the one or more processors, the computer-executable instructions of the multi-device selection system 102 can cause the computing device(s) to perform the methods described herein. Alternatively, the components can include hardware, such as a special purpose processing device to perform a certain function or group of functions. Alternatively, the components of the multi-device selection system 102 can include a combination of computer-executable instructions and hardware.

Furthermore, the components of the multi-device selection system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

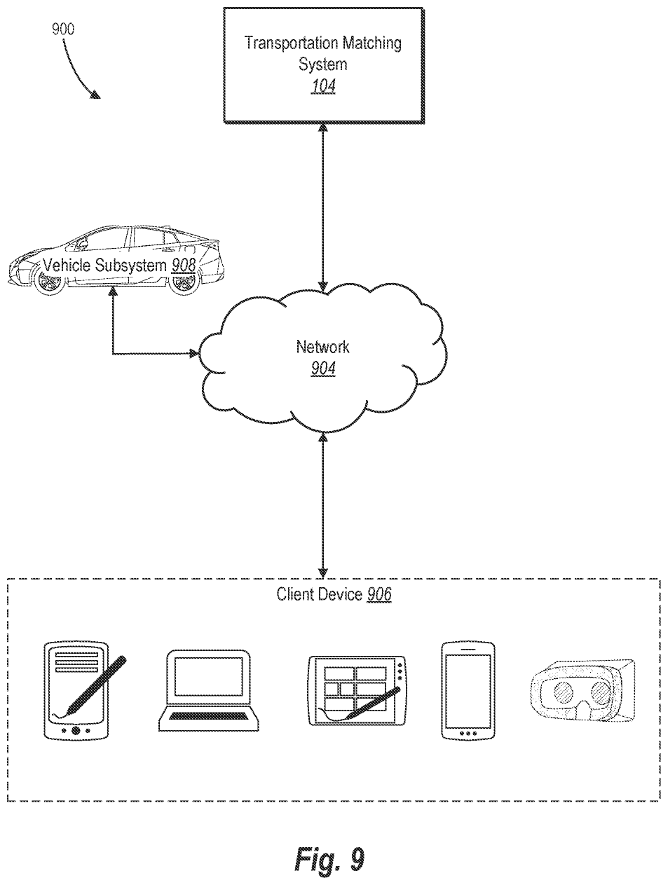

FIG. 9 illustrates an example network environment 900 of a transportation matching system (e.g., the transportation matching system 104). The network environment 900 includes a client device 906, a transportation matching system 104, and a vehicle subsystem 908 connected to each other by a network 904. Although FIG. 9 illustrates a particular arrangement of the client device 906, the transportation matching system 104, the vehicle subsystem 908, and the network 904, this disclosure contemplates any suitable arrangement of the client device 906, the transportation matching system 104, the vehicle subsystem 908, and the network 904. As an example, and not by way of limitation, two or more of the client device 906, the transportation matching system 104, and the vehicle subsystem 908 communicate directly, bypassing the network 904. As another example, two or more of the client device 906, the transportation matching system 104, and the vehicle subsystem 908 may be physically or logically co-located with each other in whole or in part. Moreover, although FIG. 9 illustrates a particular number of the client devices 906, the transportation matching system 104, the vehicle subsystems 908, and the networks 904, this disclosure contemplates any suitable number of the client devices 906, the transportation matching system 104, the vehicle subsystems 908, and the networks 904. As an example, and not by way of limitation, the network environment 900 may include multiple client devices 906, transportation matching system 104, multiple vehicle subsystems 908, and multiple networks 904.

This disclosure contemplates any suitable network 904. As an example, and not by way of limitation, one or more portions of the network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 904 may include one or more networks 904.

Links may connect the client device 906, the transportation matching system 104, and the vehicle subsystem 908 to the network 904 or to each other. This disclosure contemplates any suitable links. In particular embodiments, one or more links include one or more wireline (such as, for example, Digital Subscriber Line (“DSL”) or Data Over Cable Service Interface Specification (“DOCSIS”)), wireless (such as, for example, Wi-Fi or Worldwide Interoperability for Microwave Access (“WiMAX”)), or optical (such as, for example, Synchronous Optical Network (“SONET”) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by the client device 906. As an example, and not by way of limitation, a client device 906 may include any of the computing devices discussed above in relation to FIG. 8. A client device 906 may enable a network user at the client device 906 to access a network. A client device 906 may enable its user to communicate with other users at other client devices 906.

In particular embodiments, the client device 906 may include a transportation service application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as the server(s) 106), and the web browser may generate a Hyper Text Transfer Protocol (“HTTP”) request and communicate the HTTP request to the server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the transportation matching system 104 may be a network-addressable computing system that can host a ride share transportation network. The transportation matching system 104 may generate, store, receive, and send data, such as, for example, user-profile data, concept-profile data, text data, ride request data, GPS location data, provider data, requestor data, vehicle data, or other suitable data related to the ride share transportation network. This may include authenticating the identity of providers and/or vehicles who are authorized to provide ride services through the transportation matching system 104. In addition, the transportation service system may manage identities of service requestors such as users/requestors. In particular, the transportation service system may maintain requestor data such as driving/riding histories, personal data, or other user data in addition to navigation and/or traffic management services or other location services (e.g., GPS services).

In particular embodiments, the transportation matching system 104 may manage ride matching services to connect a user/requestor with a vehicle and/or provider. By managing the ride matching services, the transportation matching system 104 can manage the distribution and allocation of vehicle subsystem resources and user resources such as GPS location and availability indicators, as described herein.

The transportation matching system 104 may be accessed by the other components of the network environment 900 either directly or via network 904. In particular embodiments, the transportation matching system 104 may include one or more server(s). Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the transportation matching system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 906 or the transportation matching system 104 to manage, retrieve, modify, add, or delete, the information stored in data storage.

In particular embodiments, the transportation matching system 104 may provide users with the ability to take actions on various types of items or objects, supported by the transportation matching system 104. As an example, and not by way of limitation, the items and objects may include ride share networks to which users of the transportation matching system 104 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in the transportation matching system 104 or by an external system of a third-party system, which is separate from the transportation matching system 104 and coupled to the transportation matching system 104 via the network 904.

In particular embodiments, the transportation matching system 104 may be capable of linking a variety of entities. As an example, and not by way of limitation, the transportation matching system 104 may enable users to interact with each other or other entities, or to allow users to interact with these entities through an application programming interfaces (“API”) or other communication channels.

In particular embodiments, the transportation matching system 104 may include a variety of servers, sub-systems, programs, modules, logs, and data stores. In particular embodiments, the transportation matching system 104 may include one or more of the following:

a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The transportation matching system 104 may also include suitable components such as network interfaces, security mechanisms, load balancers, failover servers, management-and-network-operations consoles, other suitable components, or any suitable combination thereof. In particular embodiments, the transportation matching system 104 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between the transportation matching system 104 and one or more client devices 906. An action logger may be used to receive communications from a web server about a user's actions on or off the transportation matching system 104. In conjunction with the action log, a third-party-content-object log may be maintained of user exposures to third-party-content objects. A notification controller may provide information regarding content objects to the client device 906. Information may be pushed to the client device 906 as notifications, or information may be pulled from the client device 906 responsive to a request received from the client device 906. Authorization servers may be used to enforce one or more privacy settings of the users of the transportation matching system 104. A privacy setting of a user determines how particular information associated with a user can be shared. The authorization server may allow users to opt in to or opt out of having their actions logged by the transportation matching system 104 or shared with other systems, such as, for example, by setting appropriate privacy settings. Third-party-content-object stores may be used to store content objects received from third parties.

Location stores may be used for storing location information received from the client devices 906 associated with users.

In addition, the vehicle subsystem 908 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 908 can include an autonomous vehicle—e.g., a vehicle that does not require a human operator. In these embodiments, the vehicle subsystem 908 can perform maneuvers, communicate, and otherwise function without the aid of a human provider, in accordance with available technology.

In particular embodiments, the vehicle subsystem 908 may include one or more sensors incorporated therein or associated thereto. For example, sensor(s) can be mounted on the top of the vehicle subsystem 908 or else can be located within the interior of the vehicle subsystem 908. In certain embodiments, the sensor(s) can be located in multiple areas at once—i.e., split up throughout the vehicle subsystem 908 so that different components of the sensor(s) can be placed in different locations in accordance with optimal operation of the sensor(s). In these embodiments, the sensor(s) can include a LIDAR sensor and an inertial measurement unit (“IMU”) including one or more accelerometers, one or more gyroscopes, and one or more magnetometers. The sensor suite can additionally or alternatively include a wireless IMU (“WIMU”), one or more cameras, one or more microphones, or other sensors or data input devices capable of receiving and/or recording information relating to navigating a route to pick up, transport, and/or drop off a requestor.

In particular embodiments, the vehicle subsystem 908 may include a communication device capable of communicating with the client device 906 and/or the transportation matching system 104. For example, the vehicle subsystem 908 can include an on-board computing device communicatively linked to the network 904 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, at a transportation matching system, a set of transportation requests from requestor devices;
selecting a plurality of transportation requests from the set of transportation requests to provide to a provider computing device by comparing transportation routes for the set of transportation requests to a location of the provider computing device;
providing, for display on the provider computing device, an interactive digital map and selectable elements indicating the plurality of transportation requests; and
in response to receiving a selection of a selectable element of the selectable elements, transmitting navigation instructions to the provider computing device to a pickup location of a transportation request corresponding to the selectable element.

2. The method of claim 1, further comprising, for the transportation request, selecting a set of provider computing devices to receive the transportation request, the set of provider computing devices comprising the provider computing device and an additional provider computing device.

3. The method of claim 2, further comprising:
providing the selectable element indicating the transportation request for display via the provider computing device; and
providing an additional selectable element indicating the transportation request for display via the additional provider computing device.

4. The method of claim 3, further comprising providing the additional selectable element indicating the transportation request for display with an additional interactive digital map and additional selectable elements indicating an additional plurality of transportation requests via the additional provider computing device.

5. The method of claim 3, further comprising:
determining matching probabilities for provider computing devices; and
selecting a number of provider devices in the set of provider computing devices to receive the transportation request based on the matching probabilities.

6. The method of claim 4, further comprising, in response to receiving the selection of the selectable element via the provider computing device, removing the additional selectable element indicating the transportation request from the additional provider computing device.

7. The method of claim 1, further comprising:
for the transportation request, selecting between a multi-request transportation model and a single-request transportation model based on an elapsed time corresponding to the transportation request; and
utilizing the multi-request transportation model to select the plurality of transportation requests to provide to the provider computing device.

8. The method of claim 1, wherein providing the selectable elements for display on the provider computing device comprises providing a plurality of pickup location indicators and a plurality of transportation values corresponding to the plurality of transportation requests.

9. The method of claim 1, further comprising:
providing, for display via the interactive digital map, a first route corresponding to a first transportation request of the plurality of transportation requests; and
in response to selection of the selectable element, providing, for display via the interactive digital map, a second transportation route corresponding to the transportation request.

10. A non-transitory computer-readable medium storing instructions that, when executed by at least one processor, cause a computer system to:
receive, at a transportation matching system, a set of transportation requests from requestor devices;
select a plurality of transportation requests from the set of transportation requests to provide to a provider computing device by comparing transportation routes for the set of transportation requests to a location of the provider computing device;
provide, for display on the provider computing device, an interactive digital map and selectable elements indicating the plurality of transportation requests; and
in response to receiving a selection of a selectable element of the selectable elements, transmit navigation instructions to the provider computing device to a pickup location of a transportation request corresponding to the selectable element.

11. The non-transitory computer-readable medium of claim 10, further comprising instructions that, when executed by the at least one processor, cause the computer system to:
select a set of provider computing devices to receive the transportation request, the set of provider computing devices comprising the provider computing device and an additional provider computing device.

12. The non-transitory computer-readable medium of claim 11, further comprising instructions that, when executed by the at least one processor, cause the computer system to:
provide the selectable element indicating the transportation request for display via the provider computing device; and
provide an additional selectable element indicating the transportation request for display via the additional provider computing device.

13. The non-transitory computer-readable medium of claim 12, further comprising instructions that, when executed by the at least one processor, cause the computer system to:
provide the additional selectable element indicating the transportation request for display with an additional interactive digital map and additional selectable elements indicating an additional plurality of transportation requests via the additional provider computing device.

14. The non-transitory computer-readable medium of claim 12, further comprising instructions that, when executed by the at least one processor, cause the computer system to:
determine matching probabilities for provider computing devices; and
select a number of provider devices in the set of provider computing devices to receive the transportation request based on the matching probabilities.

15. The non-transitory computer-readable medium of claim 10, further comprising instructions that, when executed by the at least one processor, cause the computer system to:
select between a multi-request transportation model and a single-request transportation model based on an elapsed time corresponding to the transportation request; and
utilize the multi-request transportation model to select the plurality of transportation requests to provide to the provider computing device.

16. A system comprising:
at least one processor; and
at least one non-transitory computer-readable storage medium storing instructions that, when executed by the at least one processor, cause the system to:
receive, at a transportation matching system, a set of transportation requests from requestor devices;
select a plurality of transportation requests from the set of transportation requests to provide to a provider computing device by comparing transportation routes for the set of transportation requests to a location of the provider computing device;
provide, for display on the provider computing device, an interactive digital map and selectable elements indicating the plurality of transportation requests; and
in response to receiving a selection of a selectable element of the selectable elements, transmit navigation instructions to the provider computing device to a pickup location of a transportation request corresponding to the selectable element.

17. The system of claim 16, further comprising instructions that, when executed by the at least one processor, cause the system to:
select a set of provider computing devices to receive the transportation request, the set of provider computing devices comprising the provider computing device and an additional provider computing device.

18. The system of claim 17, further comprising instructions that, when executed by the at least one processor, cause the system to:
provide the selectable element indicating the transportation request for display via the provider computing device; and
provide an additional selectable element indicating the transportation request for display via the additional provider computing device.

19. The system of claim 18, further comprising instructions that, when executed by the at least one processor, cause the system to:
provide the additional selectable element indicating the transportation request for display with an additional interactive digital map and additional selectable elements indicating an additional plurality of transportation requests via the additional provider computing device.

20. The system of claim 18, further comprising instructions that, when executed by the at least one processor, cause the system to:
determine matching probabilities for provider computing devices; and
select a number of provider devices in the set of provider computing devices to receive the transportation request based on the matching probabilities.
